(19) United States
(12) Patent Application Publication
(10) Pub. No.: US 2018/0256943 A1
(43) Pub. Date: Sep. 13, 2018

(54) GOLF BALL CONSTRUCTIONS INCORPORATING THERMOSET AND/OR THERMOPLASTIC COMPOSITIONS COMPRISING TRIGONAL BIPYRAMIDALLY COORDINATED METAL CATIONS

(71) Applicant: Acushnet Company, Fairhaven, MA (US)

(72) Inventors: Dennis Britton, Dartmouth, MA (US); Brian Comeau, Berkley, MA (US)

(73) Assignee: Acushnet Company, Fairhaven, MA (US)

(21) Appl. No.: 15/456,790

(22) Filed: Mar. 13, 2017

(51) Int. Cl. A63B 37/00; A63B 45/00; C08L 23/00

(52) U.S. Cl. CPC A63B 37/0023; A63B 37/0022; A63B 45/00; C08L 23/00; A63B 37/0029; A63B 37/0024; A63B 37/0026; A63B 37/0027; A63B 37/0003

(57) ABSTRACT

Golf ball comprising layer(s) consisting of mixture of layer composition and trigonal bipyramidal coordination complex composition comprising trigonal bipyramidally coordinated metal cations. Example includes formula AM₁₋ₓM′ₓM″_{y}O_{3+y}; A comprising at least one of Mg, Sc, Y, Ti, Fe, Zn, Al, Ga, In, Sn, Gd, Td, Dy, Ho, Er, Tm, Yb, or Lu; M comprising at least one of Mg, Sc, Y, Ti, Fe, Zn, Al, Ga, In, Sn, Gd, Td, Dy, Ho, Er, Tm, or Yb; or a 1:1 mixture of M_{A} and M_{B} cations, wherein M_{A} is at least one of Zn, Mg, or Cu; and M_{B} is at least one of Ti or Sn; M′ is at least one of Mn, Fe, Al, Ga, In; and M″ is at least one of Mg, Zn, or Cu; and 0.8≥x.>0.0; and y is an integer from 0 to 15. In one embodiment, A is Y, M is In, M′ is Mn, y=0, and 1.0.>x.>0.0.

### FIELD OF THE INVENTION

Golf balls incorporating durable and sustainably bright and/or intensely colored materials.

### BACKGROUND OF THE INVENTION

Conventional golf balls can be divided into two general classes: solid and wound. Solid golf balls include one-piece, two-piece (i.e., single layer core and single layer cover), and multi-layer (i.e., solid core of one or more layers and/or a cover of one or more layers) golf balls. Wound golf balls typically include a solid, hollow, or fluid-filled center, surrounded by a tensioned elastomeric material, and a cover.

Examples of golf ball materials range from rubber materials, such as balata, styrene butadiene, polybutadiene, or polyisoprene, to thermoplastic or thermoset resins such as ionomers, polyolefins, polyamides, polyesters, polyurethanes, polyureas and/or polyurethane/polyurea hybrids, and blends thereof. Typically, outer layers are formed about the spherical outer surface of an innermost golf ball layer via compression molding, casting, or injection molding.

From the perspective of a golf ball manufacturer, it is desirable to have materials exhibiting a wide range of properties, such as resilience, durability, spin, and “feel,” because this enables the manufacturer to make and sell golf balls suited to differing levels of ability and/or preferences. In this regard, playing characteristics of golf balls, such as spin, feel, CoR and compression can be tailored by varying the properties of the golf ball materials and/or adding additional golf ball layers such as at least one intermediate layer disposed between the cover and the core. Intermediate layers can be of solid construction, and have also been formed of a tensioned elastomeric winding. The difference in play characteristics resulting from these different types of constructions can be quite significant.

Meanwhile, golfers enjoy distinguishing themselves on the course by playing a golf ball having a unique and/or aesthetically pleasing visual appearance. Golf ball manufacturers therefore continuously seek to construct the brightest white or most vibrantly colored golf balls that are also durable. For example, brighter and less yellow appearing whites have been achieved by adding blue pigments to golf ball compositions.

Unfortunately, color agents typically contain chromophores, which are generally vulnerable to photodegradation when atoms in a chromophore absorb damaging photons within the wavelengths found in sunlight (i.e., infrared radiation, visible light, and ultraviolet light). Damaging photons can break down bonds between atoms, thereby changing the atomic configuration within each chromophore—resulting in color fading. While stabilizer packages are often used to improve light stability, such improvement can be temporary. Additionally, stabilizer packages have been known to actually contribute to discoloration of the layer as well.

Accordingly, it has been difficult to develop vibrant chromophore-based colorant options that remain appealing longer term and are still safe and produce a durable golf ball displaying desirable playing characteristics. In this regard, very vibrant blue pigments, such as cobalt blue (CoAl₂O₄), ultramarine (Na₇Al₆Si₆O₂₄S₃), Prussian blue (Fe₄[Fe(CN₆)]₃), and azurite (Cu₃(CO₃)₂(OH)₂) have been tried but suffer from environmental and/or durability issues. In particular, cobalt is considered to be highly toxic, ultramarine manufacture produces a large amount of SO₂ emissions, and Prussian blue liberates HCN under mild acidic conditions. Additionally, ultramarine and azurite are not stable with respect to heat and acidic conditions. Phthalocyanine, a bright crystalline synthetic organic blue pigment available since the 1930's, has more recently been noted as possibly causing serious birth defects in developing embryos.

The polymeric portion of a golf ball material can begin to degrade as early as during manufacture, due to the extreme processing conditions under which golf balls are typically made and continue when exposed to UV light/rays. In particular, such exposure can initiate deteriorating photochemical processes in golf ball polymers containing UV absorbent groups or impurities. This can negatively impact desired physical properties, durability, and/or targeted golf ball playing characteristics. And once again, any improvement provided by stabilizer packages can be temporary and/or actually contribute to discoloration the polymeric composition.

Accordingly, there is a continued need for safe, durable, chromophore-friendly durable golf ball formulations that possess excellent physical properties and yet produce a wide range of vibrant color appearances that can remain appealing throughout the weathering process, especially compared with conventionally colored/brightened golf balls. Such golf balls, if meanwhile producible cost effectively and within existing golf ball manufacturing processes, would be very useful and desirable. Golf balls of the present invention and methods of making same address and solve these needs.

### SUMMARY OF THE INVENTION

A golf ball of the invention therefore comprises at least one layer having a spherical outer surface and consisting of a mixture of a layer composition and a trigonal bipyramidal coordination complex composition. The trigonal bipyramidal coordination complex composition comprises trigonal bipyramidally coordinated metal cations to create a predetermined overall golf ball color appearance. The predetermined overall color appearance remains appealing notwithstanding weathering, especially compared with conventionally colored/brightened golf balls, due at least in part to the synergy between the layer composition and the trigonal bipyramidal coordination complex composition within the mixture. The trigonal bipyramidal coordination complex composition becomes dispersed throughout and remains fixed within a polymer matrix of the layer composition rather than being migratory. Thus, the at least one layer is reliably durable—both on the golf ball surface against the tremendous impact and force of a club striking the golf ball, as well as at interfaces between the at least one layer and adjacent layers.

In one embodiment, the trigonal bipyramidal coordination complex composition may satisfy the general formula AM₁₋ₓM′ₓM″_{y}O_{3+y} wherein A comprises at least one of Mg, Sc, Y, Ti, Fe, Zn, Al, Ga, In, Sn, Gd, Td, Dy, Ho, Er, Tm, Yb, or Lu; wherein M comprises (i) at least one of Mg, Sc, Y, Ti, Fe, Zn, Al, Ga, In, Sn, Gd, Td, Dy, Ho, Er, Tm, or Yb; or (ii) a 1:1 mixture of M_{A} and M_{B} cations, wherein M_{A} is at least one of Zn, Mg, or Cu; and M_{B} is at least one of Ti or Sn; wherein M′ is at least one of Mn, Fe, Al, Ga, In; and wherein M″ is at least one of Mg, Zn, or Cu; and wherein 0.8≥x>0.0; and y is an integer from 0 to 15.

In a particular such embodiment, A is Y, M is In, M′ is Mn, and y=0, and 1.0.>x.>0.0 such that the predetermined overall golf ball color appearance is blue in the CIE L*a*b* color space.

In one embodiment, the layer composition may comprise a thermoset polyurethane, and the layer may have a cover hardness of from about 30 Shore D to about 70 Shore D. In another embodiment, the layer composition may comprise a thermoplastic polyurethane and the layer may have a cover hardness of from about 30 Shore D to about 70 Shore D. In yet another embodiment, the layer composition may comprises an ionomer and the layer may have a cover hardness of from about 30 Shore D to about 70 Shore D. In still another embodiment, the layer composition may comprise a thermoset rubber and the layer may have a surface hardness of from about 45 Shore C to about 95 Shore C.

The at least one layer may be any or each of a cover layer, a core layer, intermediate layer and/or a coating layer.

In one embodiment, the layer is a coating layer, wherein the mixture may achieve a Sward rocker hardness of about 5 or greater in about 60 minutes or less. In another embodiment, the mixture of the coating layer may achieve a Sward rocker hardness of about 10 or greater in about 60 minutes or less. In yet another embodiment, the mixture of the coating layer may have a fully cured Sward rocker hardness of from about 30 to 80.

In a different embodiment, the mixture of the coating layer may have a pencil hardness of 3H or less. In another embodiment, the mixture of the coating layer may have a pencil hardness of HB or less. In yet another embodiment, the mixture of the coating layer may have a pencil hardness of from about 3H to about 7H.

In one embodiment, the layer composition may be a coating layer composition comprising at least one of a latex, a lacquer, and an enamel. The coating layer composition may comprise at least one of a urethane, an acrylic, an epoxy, a urethane acrylate, and an alkyd.

The layer composition may be opaque or translucent.

In a particular embodiment, the predetermined overall golf ball color appearance may be tinted white, wherein the layer composition comprises a white pigment, and the trigonal bipyramidal coordination complex composition produces blue hue sufficient to create a tinted white overall golf ball color appearance that is brighter than a white color appearance of the layer composition. In one such embodiment, the mixture comprises the blue pigment in an amount of from about 0.001 wt. % to about 0.5 wt. % of the total weight % of the mixture.

In one embodiment of a golf ball of the invention, a color appearance of the golf ball as represented in the CIE L*a*b* color space may have an L* value that is between an L* value of the layer composition and an L* value of the trigonal bipyramidal coordination complex composition. In one such embodiment, the trigonal bipyramidal coordination complex composition may be included in the mixture in an amount such that the color appearance of the golf ball has an L* value in the CIE L*a*b* color space that is closer to an L* value of the trigonal bipyramidal coordination complex composition than to an L* value of the layer composition.

In one embodiment, the layer composition and the trigonal bipyramidal coordination complex composition may have substantially similar a* values and b* values in the CIE L*a*b* color space. In another embodiment, the layer composition and the trigonal bipyramidal coordination complex composition may have different a* values, b* values, or different a* values and b* values.

In another embodiment, the layer composition may have an L* value in the CIE L*a*b* color space that is substantially similar to an L* value of the trigonal bipyramidal coordination complex composition.

In a particular embodiment, the color appearance of the golf ball has an a* value in the CIE L*a*b* color space that is closer to an a* value of the trigonal bipyramidal coordination complex composition than to an a* value of the layer composition. In some embodiments, the color appearance of the golf ball additionally or alternatively has a b* value in the CIE L*a*b* color space that is closer to a b* value of the trigonal bipyramidal coordination complex composition than to a b* value of the layer composition.

In other embodiments, the mixture itself may have an L* value in the CIE L*a*b* color space that is between an L* value of the layer composition and an L* value of the trigonal bipyramidal coordination complex composition. And in one such particular embodiment, the trigonal bipyramidal coordination complex composition may be included in the mixture in an amount such that the mixture has an L* value in the CIE L*a*b* color space that is closer to an L* value of the trigonal bipyramidal coordination complex composition than to an L* value of the layer composition.

In a specific non-limiting embodiment, the trigonal bipyramidal coordination complex composition is included in the mixture in an amount of from about 1 wt. % to about 5 wt. % of the total wt. % of the mixture.

The invention also relates to a method of making a golf ball of the invention comprising the steps of: providing a subassembly having a spherical outer surface; and forming at least one layer about the outer surface, wherein at least one of the subassembly and the at least one layer consists of a mixture of a layer composition and a trigonal bipyramidal coordination complex composition that comprises trigonal bipyramidally coordinated metal cations to create a predetermined overall golf ball color appearance.

### DETAILED DESCRIPTION

A golf ball of the invention incorporates at least one layer consisting of a mixture of a layer composition and a trigonal bipyramidal coordination complex composition to create a vibrant and intense golf ball color appearance that remains appealing notwithstanding weathering, especially compared with conventionally colored/brightened golf balls, and meanwhile without sacrificing desired physical properties and durability. Advantageously, the ingredients used to produce the vibrant and intense golf ball color appearance are non-toxic, abundantly available, as well as extremely heat stable and resistant to acid attack.

Specifically, a golf ball of the invention comprises at least one layer having a sphereical outer surface and consisting of a mixture of the layer composition and trigonal bipyramidal coordination complex composition. The trigonal bipyramidal coordination complex composition comprises trigonal bipyramidally coordinated metal cations to create a predetermined overall golf ball color appearance. The predetermined overall color appearance remains intense and vibrantly appealing throughout the weathering process, especially compared with conventionally colored/brightened golf balls, due at least in part to the synergy between the layer composition and the trigonal bipyramidal coordination complex composition within the mixture.

At least one color within the range of wavelengths of visible light may therefore be created and apparent on the spherically shaped outer surface of a golf ball layer containing the mixture. Meanwhile, the mixture possesses great hiding power with respect to pick marks that sometimes form on a golf ball/layer surface during transfer within the manufacture/assembly process.

Trigonal bipyramidal geometry is found when a central atom in a molecule forms bonds to five peripheral atoms at the corners of a trigonal dipyramid. Three of the atoms are arranged in a planar triangle around the central atom with a bond angle of 120 degrees between the peripheral atoms; these atoms are called equatorial, or basal, atoms. The remaining two atoms are located above and below the central atom, and are called axial, or apical, atoms. There is a bond angle of 90 degrees between the axial and equatorial atoms. See, e.g., U.S. Pat. No. 8,282,728 of Subramanian et al. (“the '728 patent”), hereby incorporated by reference herein in its entirety.

The trigonal bipyramidal coordination complex composition may satisfy the general formula AM₁₋ₓM′ₓM″_{y}O_{3+y} wherein A comprises at least one of Mg, Sc, Y, Ti, Fe, Zn, Al, Ga, In, Sn, Gd, Td, Dy, Ho, Er, Tm, Yb, or Lu; wherein M comprises (i) at least one of Mg, Sc, Y, Ti, Fe, Zn, Al, Ga, In, Sn, Gd, Td, Dy, Ho, Er, Tm, or Yb; or (ii) a 1:1 mixture of M_{A} and M_{B} cations, wherein M_{A} is at least one of Zn, Mg, or Cu; and M_{B} is at least one of Ti or Sn; wherein M′ is at least one of Mn, Fe, Al, Ga, In; and wherein M″ is at least one of Mg, Zn, or Cu; and wherein 0.8≥x.>0.0; and y is an integer from 0 to 15.

At least one metal selected from Mn, Fe, Al, Ga, or In may be bound to oxygen in the trigonal bipyramidal configuration. The Mn, Fe, Al, Ga, In, or a combination thereof may be introduced into the trigonal bipyramidal sites of metal oxides. The oxygen atoms may occupy all five sites coordinated to the central metal in the trigonal bipyramid.

In one particular such embodiment, A is Y, M is In, M′ is Mn, and y=0, and 1.0.>x.>0.0 such that the predetermined overall golf ball color appearance is blue in the CIE L*a*b* color space.

Without being bound to a particular theory, an apparent intense surface color results from the specific crystal field splitting associated with a pre-selected trigonal bipyramidal coordination when light interacts with the mixture in or through the spherical surface of the golf ball. In this regard, it is M′ (at least one of Mn, Fe, Al, Ga, In) that is/are bound to oxygen in a trigonal bipyramidal configuration. Examples of suitable trigonal bipyramidal structures for use in the trigonal bipyramidal coordination complex composition portion of the mixture are set forth in the '728 patent.

Meanwhile, the type of layer composition selected can also impact the apparent color appearance that the mixture produces. Advantageously, the layer composition portion of the mixture may comprise suitable golf ball materials such as ionomer(s); non-ionomeric acid polymer(s); non-acid polymer(s); polyurethane(s), polyurea(s), and polyurethane-polyurea hybrid(s); polyester-based thermoplastic elastomer(s); polyamide(s), copolymers of ionomer(s) and polyamide(s), polyamide-ether(s), and polyamide-ester(s); ethylene-based homopolymer(s) and copolymer(s); propylene-based homopolymer(s) and copolymer(s); triblock copolymer(s) based on styrene and ethylene/butylene; and derivatives thereof that are compatibilized with at least one grafted or copolymerized functional group; polybutadiene(s), ethylene propylene rubber (EPR); ethylene-propylene-diene rubber (EPDM); styrene-butadiene rubber; butyl rubber, halobutyl rubber; acrylonitrile butadiene rubber; polychloroprene; alkyl acrylate rubber; polyalkenamer; phenol formaldehyde; melamine formaldehyde; polyepoxide; polysiloxane; polyester(s); alkyd(s); polyisocyanurate(s); polycyanurate(s); polyacrylate(s); or combinations thereof.

Moreover, interactions between the trigonal bipyramidal coordination complex composition and the layer composition create a strong and stationary network of layer materials with a continuously robust appearance notwithstanding weathering, especially compared with conventionally colored/brightened golf balls. The trigonal bipyramidal coordination complex composition becomes dispersed throughout and remains fixed within a polymer matrix of the layer composition, thereby avoiding adhesion problems which typically result when golf ball ingredients migrate from within a layer toward its inner and/or outer surface(s) at an interface between that layer and another layer. Also avoided are the durability issues that can result on the golf ball's outermost surface when conventional pigments migrate to that outermost/innermost surface which can change/reduce the outermost surface's ability to withstand the tremendous force and impact of a club face striking the golf ball, and the innermost surface's ability to remain adhered to an adjacent inner layer after repeated blows.

The shade of apparent color produced by the mixture can vary (darken) along a color continuum as the value of x in M′ₓ increases. See, e.g., Id., '728 patent. Meanwhile, the intensity of a predetermined overall color appearance may also be increased in a mixture of the invention in some instances by raising the loading or weight percent (wt %) of trigonal bipyramidal coordination complex composition within the mixture, especially when the layer composition portion of the mixture does not itself contain a colorant such as conventional pigments.

In one embodiment, the mixture of layer composition and trigonal bipyramidal coordination complex composition may create a predominantly blue vibrant color appearance with a peak wavelength of from about 455 nm to 492 nm. In another embodiment, the mixture of layer composition and trigonal bipyramidal coordination complex composition may create a predominantly violet color appearance with a peak wavelength of from about 390 nm to 455 nm. In yet another embodiment, the mixture of layer composition and trigonal bipyramidal coordination complex composition may create a predominantly green color appearance with a peak wavelength of from about 492 nm to 577 nm. In still another embodiment, the mixture of layer composition and trigonal bipyramidal coordination complex composition may create a predominantly yellow color appearance with a peak wavelength of from about 577 nm to 597 nm. In an alternative embodiment, the mixture of layer composition and trigonal bipyramidal coordination complex composition may create a predominantly orange color appearance with a peak wavelength of from about 597 nm to 620 nm. In a different embodiment, the mixture of layer composition and trigonal bipyramidal coordination complex composition may create a predominantly red color appearance with a peak wavelength of from about 620 nm to 780 nm.

Embodiments are also envisioned wherein an apparent color appearance may be produced having two or more colors within the spectrum of visible light by incorporating/mixing two or more trigonal bipyramidal coordination complex compositions and then co-mixing same with the layer composition.

Alternatively, this can be achieved by mixing a first trigonal bipyramidal coordination complex composition with the layer composition first, followed by admixing same with a second trigonal bipyramidal coordination complex composition, wherein the first and second trigonal bipyramidal coordination complex compositions create different apparent color appearances and different attendant peak wavelengths, and which, together, produce the color appearance that is visible on the spherical outer surface of an inventive golf ball and/or golf ball layer.

The inventive mixture of layer composition and trigonal bipyramidal coordination complex composition can be formed into a spherical inner core (center) or formed as a layer about any golf ball subassembly. In some embodiments, one or more coating layers may be formed about a subassembly which may one piece, two piece, etc. Such cotaing layer(s) is/are durable enough to withstand the great force a golf club face striking same, and yet provide the vibrant color appearance that will still appear vibrant under weathering.

In this regard, nicks sometimes form in the surface of a coating being struck by the club face, which often results in exposing underlying golf ball layers and leads to delamination. In such embodiments, golf balls are envisioned having any possible number of such coating layers of inventive mixture. In one embodiment, the layer composition is a coating layer composition comprising at least one of a latex, a lacquer, and an enamel. The coating layer composition may comprise at least one of a urethane, an acrylic, an epoxy, a urethane acrylate, and an alkyd.

In one embodiment, a coating layer of inventive mixture having a pencil hardness of 3H or less may surround a subassembly. In another embodiment, a coating layer of inventive mixture having a pencil hardness of HB or less may surround the subassembly. In yet another embodiment, the coating layer of inventive mixture may have a pencil hardness of from about 3H to about 7. In still another embodiment, the coating layer of inventive mixture may have a pencil hardness of from about 5H to to about 6H. Pencil hardness testing may be performed according to ASTM D3363.

In a different embodiment, a coating layer of inventive mixture achieving a Sward rocker hardness of about 5 or greater in about 60 minutes or less may surround a subassembly. In another embodiment, a coating layer achieving a Sward rocker hardness of about 10 or greater in about 60 minutes may surround the subassembly. In yet another embodiment, a coating layer of inventive mixture achieving a Sward rocker hardness of about 10 or greater in about 30 minutes or less may surround the subassembly. In still another embodiment, a coating layer of inventive mixture achieving a Sward rocker hardness of about 10 or greater in about 15 minutes or less may surround the subassembly. In an alternative embodiment, a coating layer of inventive mixture achieving a Sward rocker hardness of about 10 or greater in about 10 minutes or less surrounds the subassembly.

In different embodiments, a coating layer of inventive mixture may have a fully cured Sward rocker hardness of from about 30 to 80, or from about 40 to 70, or from about 45 to 65, or less than about 40. Sward rocker hardness may be ascertained via ASTM D 2134-66.

Thus, golf balls of the invention can include one or more layers of inventive mixture in any or each of the coating or cover layer, as well as in one or more core layers or intermediate layers. Regardless, the at least one layer may be opaque or translucent. Embodiments are also envisioned, however, wherein the at least one layer is clear colored.

Embodiments are also envisioned wherein such coating layer(s) surround at least one cover layer that also contains an inventive mixture of layer composition and structure composition.

In cover layers consisting of an inventive mixture, the layer composition may for example comprise a thermoset polyurethane and the layer may have a cover hardness of from about 30 Shore D to about 70 Shore D. In alternative embodiments, the layer may have a cover hardness of from about 30 Shore D to about 60 Shore D, or from about 30 Shore D to about 45 Shore D, or from about 40 Shore D to about 70 Shore D, or from about 40 Shore D to about 60 Shore D, or from about 45 Shore D to about 60 Shore D.

In another embodiment, the layer composition may comprise a thermoplastic polyurethane and the layer may have a cover hardness of from about 30 Shore D to about 70 Shore D. In alternative embodiments, the layer may have a cover hardness of from about 30 Shore D to about 60 Shore D, or from about 30 Shore D to about 45 Shore D, or from about 40 Shore D to about 70 Shore D, or from about 40 Shore D to about 60 Shore D, or from about 45 Shore D to about 60 Shore D.

In yet another embodiment, the layer composition may comprise an ionomer and the layer may have a cover hardness of from about 30 Shore D to about 70 Shore D. In alternative embodiments, the layer may have a cover hardness of from about 30 Shore D to about 65 Shore D, or from about 30 Shore D to about 40 Shore D, or from about 35 Shore D to about 70 Shore D, or from about 45 Shore D to about 60 Shore D, or from about 35 Shore D to about 65 Shore D.

In still another embodiment, the layer composition may comprise a thermoset rubber and the layer may have a surface hardness of from about 45 Shore C to about 95 Shore C. In alternative embodiments, the layer may have a surface hardness of from about 45 Shore C to about 85 Shore C, or from about 45 Shore C to about 75 Shore C, or from about 45 Shore C to about 65 Shore C, or from about 50 Shore C to about 85 Shore C, or from about 50 Shore C to about 75 Shore C, or from about 60 Shore C to about 85 Shore C, or from about 60 Shore C to about 75 Shore C, or from about 65 Shore C to about 85 Shore C, or from about 65 Shore C to about 75 Shore C.

A golf ball layer consisting of the inventive mixture may have a thickness less than 0.002 inches. Advantageously, however, a golf ball layer of inventive mixture may have a thickness of 0.002 inches or greater. Accordingly, in some embodiments, a layer of inventive mixture may even have a thickness greater than 0.002 inches, or greater than 0.005 inches, or greater than 0.010 inches, or greater than 0.025 inches, or greater than 0.050 inches, or greater than 0.075 inches, or greater than 0.10 inches, or greater than 0.250 inches, or greater than 0.500 inches, or about 0.002 inches or greater, or about 0.005 inches or greater, or about 0.010 inches or greater, or about 0.025 inches or greater, or about 0.050 inches or greater, or about 0.075 inches or greater, or about 0.10 inches or greater, or about 0.250 inches or greater, or about 0.500 inches or greater. Meanwhile, inner cores (core center) containing inventive mixtures may have diameters ranging from about 0.02 inches up to about 1.65 inches or greater.

In a particular embodiment, a golf ball of the invention has a predetermined overall golf ball color appearance that is tinted white, wherein the layer composition comprises a white pigment, and the trigonal bipyramidal coordination complex composition produces a blue hue sufficient to create the tinted white overall golf ball color appearance. In this embodiment, the tinted white overall golf ball color appearance is brighter than a white color appearance of the layer composition.

CIE L*a*b* (CIELAB) is a color space (i.e., a model representing colors as an ordered list of three numerical values) specified by the International Commission on Illumination (Commission Internationale d′Eclairage, CIE). The three coordinates represent the lightness of the color (L*=0=black, L*=100=diffuse white), its position between red/magenta and green (a*—negative values indicate green, while positive values indicate magenta, and its position between yellow and blue (b*—negative values indicate blue and positive values indicate yellow). Id. at '728 patent In one embodiment, a color appearance of the golf ball as represented in the CIE L*a*b* color space may have an L* value that is between an L* value of the layer composition and an L* value of the trigonal bipyramidal coordination complex composition.

In one such embodiment, the trigonal bipyramidal coordination complex composition may be included in the mixture in an amount such that the color appearance of the golf ball has an L* value in the CIE L*a*b* color space that is closer to an L* value of the trigonal bipyramidal coordination complex composition than to an L* value of the layer composition.

In a particular such embodiment, the layer composition and the trigonal bipyramidal coordination complex composition may have substantially similar a* values and b* values in the CIE L*a*b* color space. In other embodiments, the layer composition and the trigonal bipyramidal coordination complex composition may have different a* values, different b* values, or different a* values and b* values.

In an alternative embodiment, the layer composition may have an L* value in the CIE L*a*b* color space that is substantially similar to an L* value of the trigonal bipyramidal coordination complex composition. In a particular such embodiment, the color appearance of the golf ball may have an a* value in the CIE L*a*b* color space that is closer to an a* value of the trigonal bipyramidal coordination complex composition than to an a* value of the layer composition. In some embodiments, the color appearance of the golf ball additionally or alternatively may have a b* value in the CIE L*a*b* color space that is closer to a b* value of the trigonal bipyramidal coordination complex composition than to a b* value of the layer composition.

In a different embodiment, the mixture may have an L* value in the CIE L*a*b* color space that is between an L* value of the layer composition and an L* value of the trigonal bipyramidal coordination complex composition. In one such embodiment, the trigonal bipyramidal coordination complex composition may be included in the mixture in an amount such that the mixture has an L* value in the CIE L*a*b* color space that is closer to an L* value of the trigonal bipyramidal coordination complex composition than to an L* value of the layer composition.

In one particular such embodiment, the layer composition and the trigonal bipyramidal coordination complex composition may have substantially similar a* values and b* values in the CIE L*a*b* color space. In another particular such embodiment, the layer composition and the trigonal bipyramidal coordination complex composition may have different a* values, b* values, or different a* values and b* values.

In an alternative embodiment, the mixture may have an L* value in the CIE L*a*b* color space that is substantially similar to an L* value of the trigonal bipyramidal coordination complex composition. In one such embodiment, the mixture may have an a* value in the CIE L*a*b* color space that is closer to an a* value of the trigonal bipyramidal coordination complex composition than to an a* value of the layer composition. In some embodiments, the mixture additionally or alternatively may have a b* value in the CIE L*a*b* color space that is closer to a b* value of the trigonal bipyramidal coordination complex composition than to a b* value of the layer composition.

In one embodiment, the trigonal bipyramidal coordination complex composition may be included in the mixture in an amount of from about 1 wt. % to about 5 wt. % of the total wt. % of the mixture. In another embodiment, the mixture may comprises the trigonal bipyramidal coordination complex composition in an amount of from about 0.001 wt. % to about 0.5 wt. % of the total weight % of the mixture.

In other embodiments, the mixture includes the trigonal bipyramidal coordination complex composition in an amount of 0.05 to 10 parts by weight per 100 parts of layer composition. In such embodiments, the mixture may include the trigonal bipyramidal coordination complex composition in an amount of 0.05 to 10, or 0.05 to 5, or 1 to 10, or 5 to 10, or greater than 5 and up to 10 parts by weight per 100 parts of layer composition.

In still other embodiments, the mixture includes the trigonal bipyramidal coordination complex composition in an amount of greater than 10 to 50 parts by weight per 100 parts of layer composition. In such embodiments, the mixture may alternatively include the trigonal bipyramidal coordination complex composition in an amount of greater than 10 to 40, or greater than 10 to 30, or greater than 10 to 25, or greater than 10 to 15, or 15 to 50, or 25 to 50, or 35 to 50, or 40 to 50, or 20 to 40, or 20 to 30, or 30 to 40, or about 15 to 50, or about 25 to 50, or about 35 to 50, or about 40 to 50, or about 20 to 40, or about 20 to 30, or about 30 to 40, parts by weight per 100 parts of layer composition.

In a method of making a golf ball of the invention, a subassembly having a spherical outer surface is provided; and at least one layer is formed about the outer surface, wherein at least one of the subassembly and at least one layer comprises a mixture of a layer composition and a trigonal bipyramidal coordination complex composition, wherein the trigonal bipyramidal coordination complex composition comprises trigonal bipyramidally coordinated metal cations to create a predetermined overall golf ball color appearance.

In some embodiments, the layer composition and/or trigonal bipyramidal coordination complex composition may additionally contain additives and/or fillers. Suitable additives and fillers include, but are not limited to, chemical blowing and foaming agents, optical brighteners, coloring agents, fluorescent agents, whitening agents, UV absorbers, light stabilizers, defoaming agents, processing aids, mica, talc, nano-fillers, antioxidants, stabilizers, softening agents, fragrance components, plasticizers, impact modifiers, TiO₂, acid copolymer wax, surfactants, and fillers, such as zinc oxide, tin oxide, barium sulfate, zinc sulfate, calcium oxide, calcium carbonate, zinc carbonate, barium carbonate, clay, tungsten, tungsten carbide, silica, lead silicate, regrind (recycled material), and mixtures thereof.

Golf balls of the invention may be formed using a variety of application techniques. For example, golf ball layers may be formed using compression molding, flip molding, injection molding, retractable pin injection molding, reaction injection molding (RIM), liquid injection molding (LIM), casting, vacuum forming, powder coating, flow coating, spin coating, dipping, spraying, and the like. Conventionally, compression molding and injection molding are applied to thermoplastic materials, whereas RIM, liquid injection molding, and casting are employed on thermoset materials.

In one embodiment, the golf ball layers may be formed using injection molding. When injection molding is used, the layer composition is typically in a pelletized or granulated form that can be easily fed into the throat of an injection molding machine wherein it is melted and conveyed via a screw in a heated barrel at temperatures of from about 150° F. to about 600° F., preferably from about 200° F. to about 500° F. The molten composition is ultimately injected into a closed mold cavity, which may be cooled, at ambient or at an elevated temperature, but typically the mold is cooled to a temperature of from about 50° F. to about 70° F. After residing in the closed mold for a time of from 1 second to 300 seconds, preferably from 20 seconds to 120 seconds, the core and/or core plus one or more additional core or cover layers is removed from the mold and either allowed to cool at ambient or reduced temperatures or is placed in a cooling fluid such as water, ice water, dry ice in a solvent, or the like.

Cores of golf balls of the invention may be formed by any suitable method known to those of ordinary skill in art. When the cores are formed from a thermoset material, compression molding is a particularly suitable method of forming the core. In a thermoplastic core embodiment, on the other hand, the cores may be injection molded.

Meanwhile, intermediate layers and/or cover layers may also be formed using any suitable method known to those of ordinary skill in the art. For example, an intermediate layer may be formed by blow molding and covered with a dimpled cover layer formed by injection molding, compression molding, casting, vacuum forming, powder coating, and the like.

As discussed briefly above, the inventive mixture may be incorporated in any known golf ball construction including, but not limited to, one-piece, two-piece, three-piece, and four or more piece designs, a double core, a double cover, an intermediate layer(s), a multilayer core, and/or a multi-layer cover depending on the type of performance desired of the golf ball. That is, the inventive mixture may be used in a core, an intermediate layer, a cover, and/or a coating of the golf ball, each of which may have a single layer or multiple layers.

In particular embodiments, the color appearance of at least one layer containing the inventive mixture may be at least partially visible from the golf ball's outermost surface. In such embodiments, any golf ball layer(s) surrounding a layer containing the inventive mixture should be one of (i) clear, transparent and colorless; or (ii) clear, transparent colored; or (iii) at least partially translucent. Meanwhile, the at least one layer of inventive mixture itself may be any of (ii), or (iii) or opaque.

However, embodiments are indeed envisioned wherein a totally opaque golf ball layer surrounds a layer containing the inventive mixture, especially in an embodiment, for example, wherein the at least one layer is intended to be noticed when/if the golf ball is halved for such reason as inspection or to prove ownership (security purpose), or as an indication of brand recognition. In some embodiments, the layer composition may incorporated in an inner golf ball layer simply due to its superiority as a golf ball material in producing great adhesion between layers and/or other desired golf ball properties/characteristics.

Golf balls of the invention can be of any size, although the USGA requires that golf balls used in competition have a diameter of at least 1.68 inches. For play outside of United States Golf Association (USGA) rules, the golf balls can be of a smaller size. Normally, golf balls are manufactured in accordance with USGA requirements and have a diameter in the range of about 1.68 to about 1.80 inches. Also, the USGA has established a maximum weight of 45.93 g (1.62 ounces) for golf balls. For play outside of USGA rules, the golf balls can be heavier. Thus, the diameter of the golf balls may be, for example, from about 1.680 inches to about 1.800 inches, or from about 1.680 inches to about 1.760 inches, or from about 1.680 inches (43 mm) to about 1.740 inches (44 mm), or even anywhere in the range of from 1.700 to about 1.950 inches.

The diameter and thickness of the different layers, along with properties such as hardness and compression, may vary depending upon the desired playing performance properties of the golf ball such as spin, initial velocity, and feel. Any one or more of the layers of any of the one, two, three, four, or five, or more-piece (layered) balls may comprise or consist of the inventive mixture. That is, any of the layers in the core assembly (for example, inner (center), intermediate, and/or outer core layers), and/or any of the layers in the cover assembly (for example, inner, intermediate, and/or outer cover layers) may comprise or consist of the inventive mixture. The term, “layer” as used herein means generally any spherical portion of the golf ball.

Accordingly, the dimensions of each golf ball component such as the diameter of the core and respective thicknesses of the intermediate layer (s), cover layer(s) and/or coating layer(s) may be selected and coordinated for targeting and achieving such desired playing characteristics or feel. In one version, a golf ball of the invention may be a one-piece ball containing the inventive mixture as the entire golf ball excluding any paint or coating and indicia applied thereon. In a second version, a two-piece golf ball comprising a single core and a single cover layer is made, wherein at least one of the single core and single cover contains the inventive mixture.

In a third version, a three-piece golf ball incorporates a dual-layered core and a single-layered cover. The dual-core includes an inner core (center) and surrounding outer core layer. In another version, a three-piece ball contains a single core layer and two cover layers. In yet another version, a four-piece golf ball contains a dual-core and dual-cover (inner cover layer and outer cover layer). In these embodiments, one or more of the layers may contain the inventive mixture.

In yet another construction, a four-piece or five-piece golf ball contains a dual-core; an inner cover layer, an intermediate cover layer, and an outer cover layer. In still another construction, a five-piece ball is made containing a three-layered core with an innermost core layer (or center), an intermediate core layer, and outer core layer, and a two-layered cover with an inner and outer cover layer. One or more of these layers may contain the inventive mixture.

The overall diameter of the core and all intermediate layers is often about 80 percent to about 98 percent of the overall diameter of the finished ball. The core may have a diameter ranging from about 0.09 inches to about 1.65 inches. In one embodiment, the diameter of the core of the present invention is about 1.2 inches to about 1.630 inches. For example, when part of a two-piece ball according to invention, the core may have a diameter ranging from about 1.5 inches to about 1.62 inches. In another embodiment, the diameter of the core is about 1.3 inches to about 1.6 inches, preferably from about 1.39 inches to about 1.6 inches, and more preferably from about 1.5 inches to about 1.6 inches. In yet another embodiment, the core has a diameter of about 1.55 inches to about 1.65 inches, preferably about 1.55 inches to about 1.60 inches.

In some embodiments, the core may have an overall diameter within a range having a lower limit of 0.500 or 0.700 or 0.750 or 0.800 or 0.850 or 0.900 or 0.950 or 1.000 or 1.100 or 1.150 or 1.200 or 1.250 or 1.300 or 1.350 or 1.400 or 1.450 or 1.500 or 1.600 or 1.610 inches and an upper limit of 1.620 or 1.630 or 1.640 inches. In a particular embodiment, the core is a multi-layer core having an overall diameter within a range having a lower limit of 0.500 or 0.700 or 0.750 or 0.800 or 0.850 or 0.900 or 0.950 or 1.000 or 1.100 or 1.150 or 1.200 inches and an upper limit of 1.250 or 1.300 or 1.350 or 1.400 or 1.450 or 1.500 or 1.600 or 1.610 or 1.620 or 1.630 or 1.640 inches. In another particular embodiment, the multi-layer core has an overall diameter within a range having a lower limit of 0.500 or 0.700 or 0.750 inches and an upper limit of 0.800 or 0.850 or 0.900 or 0.950 or 1.000 or 1.100 or 1.150 or 1.200 or 1.250 or 1.300 or 1.350 or 1.400 or 1.450 or 1.500 or 1.600 or 1.610 or 1.620 or 1.630 or 1.640 inches. In another particular embodiment, the multi-layer core has an overall diameter of 1.500 inches or 1.510 inches or 1.530 inches or 1.550 inches or 1.570 inches or 1.580 inches or 1.590 inches or 1.600 inches or 1.610 inches or 1.620 inches.

In some embodiments, the inner core can have an overall diameter of 0.500 inches or greater, or 0.700 inches or greater, or 1.00 inches or greater, or 1.250 inches or greater, or 1.350 inches or greater, or 1.390 inches or greater, or 1.450 inches or greater, or an overall diameter within a range having a lower limit of 0.250 or 0.500 or 0.750 or 1.000 or 1.250 or 1.350 or 1.390 or 1.400 or 1.440 inches and an upper limit of 1.460 or 1.490 or 1.500 or 1.550 or 1.580 or 1.600 inches, or an overall diameter within a range having a lower limit of 0.250 or 0.300 or 0.350 or 0.400 or 0.500 or 0.550 or 0.600 or 0.650 or 0.700 inches and an upper limit of 0.750 or 0.800 or 0.900 or 0.950 or 1.000 or 1.100 or 1.150 or 1.200 or 1.250 or 1.300 or 1.350 or 1.400 inches. In one embodiment, the inner core consists of a single layer formed from a thermoset rubber composition. In another embodiment, the inner core consists of two layers, each of which is formed from the same or different thermoset rubber compositions. In another embodiment, the inner core comprises three or more layers, each of which is formed from the same or different thermoset rubber compositions. In another embodiment, the inner core consists of a single layer formed from a thermoplastic composition. In another embodiment, the inner core consists of two layers, each of which is formed from the same or different thermoplastic compositions. In another embodiment, the inner core comprises three or more layers, each of which is formed from the same or different thermoplastic compositions. In these embodiments, one or more of the layers may contain the inventive mixture.

In some embodiments, the outer core layer can have an overall thickness within a range having a lower limit of 0.010 or 0.020 or 0.025 or 0.030 or 0.035 inches and an upper limit of 0.040 or 0.070 or 0.075 or 0.080 or 0.100 or 0.150 inches, or an overall thickness within a range having a lower limit of 0.025 or 0.050 or 0.100 or 0.150 or 0.160 or 0.170 or 0.200 inches and an upper limit of 0.225 or 0.250 or 0.275 or 0.300 or 0.325 or 0.350 or 0.400 or 0.450 or greater than 0.450 inches. The outer core layer may alternatively have a thickness of greater than 0.10 inches, or 0.20 inches or greater, or greater than 0.20 inches, or 0.30 inches or greater, or greater than 0.30 inches, or 0.35 inches or greater, or greater than 0.35 inches, or 0.40 inches or greater, or greater than 0.40 inches, or 0.45 inches or greater, or greater than 0.45 inches, or a thickness within a range having a lower limit of 0.005 or 0.010 or 0.015 or 0.020 or 0.025 or 0.030 or 0.035 or 0.040 or 0.045 or 0.050 or 0.055 or 0.060 or 0.065 or 0.070 or 0.075 or 0.080 or 0.090 or 0.100 or 0.200 or 0.250 inches and an upper limit of 0.300 or 0.350 or 0.400 or 0.450 or 0.500 inches.

In one embodiment, the outer core consists of a single layer formed from a thermoset rubber composition. In another embodiment, the outer core consists of two layers, each of which is formed from the same or different thermoset rubber compositions. In another embodiment, the outer core comprises three or more layers, each of which is formed from the same or different thermoset rubber compositions. In another embodiment, the outer core consists of a single layer formed from a thermoplastic composition. In another embodiment, the outer core consists of two layers, each of which is formed from the same or different thermoplastic compositions. In another embodiment, the outer core comprises three or more layers, each of which is formed from the same or different thermoplastic compositions. In these embodiments, one or more of the layers may contain the inventive mixture.

An intermediate core layer can have an overall thickness within a range having a lower limit of 0.005 or 0.010 or 0.015 or 0.020 or 0.025 or 0.030 or 0.035 or 0.040 or 0.045 inches and an upper limit of 0.050 or 0.055 or 0.060 or 0.065 or 0.070 or 0.075 or 0.080 or 0.090 or 0.100 inches. In one embodiment, the intermediate core consists of a single layer formed from a thermoset rubber composition. In another embodiment, the intermediate core consists of two layers, each of which is formed from the same or different thermoset rubber compositions. In another embodiment, the intermediate core comprises three or more layers, each of which is formed from the same or different thermoset rubber compositions. In another embodiment, the intermediate core consists of a single layer formed from a thermoplastic composition. In another embodiment, the intermediate core consists of two layers, each of which is formed from the same or different thermoplastic compositions. In another embodiment, the intermediate core comprises three or more layers, each of which is formed from the same or different thermoplastic compositions. In these embodiments, one or more of the layers may contain the inventive mixture.

The range of thicknesses for an intermediate layer of a golf ball is large because of the vast possibilities when using an intermediate layer, i.e., as an outer core layer, an inner cover layer, a wound layer, a moisture/vapor barrier layer. When used in a golf ball of the present invention, the intermediate layer, or inner cover layer, may have a thickness about 0.3 inches or less. In one embodiment, the thickness of the intermediate layer is from about 0.002 inches to about 0.1 inches, and preferably about 0.01 inches or greater. For example, when part of a three-piece ball or multi-layer ball according to the invention, the intermediate layer and/or inner cover layer may have a thickness ranging from about 0.010 inches to about 0.06 inches. In another embodiment, the intermediate layer thickness is about 0.05 inches or less, more preferably about 0.01 inches to about 0.045 inches. In these embodiments, one or more of the layers may contain the inventive mixture.

The cover typically has a thickness to provide sufficient strength, good performance characteristics, and durability. In one embodiment, the cover thickness may for example be from about 0.02 inches to about 0.12 inches, or about 0.1 inches or less. For example, the cover may be part of a two-piece golf ball and have a thickness ranging from about 0.03 inches to about 0.09 inches. In another embodiment, the cover thickness may be about 0.05 inches or less, or from about 0.02 inches to about 0.05 inches, or from about 0.02 inches and about 0.045 inches.

The cover may be a single-, dual-, or multi-layer cover and have an overall thickness for example within a range having a lower limit of 0.010 or 0.020 or 0.025 or 0.030 or 0.040 or 0.045 inches and an upper limit of 0.050 or 0.060 or 0.070 or 0.075 or 0.080 or 0.090 or 0.100 or 0.150 or 0.200 or 0.300 or 0.500 inches. In a particular embodiment, the cover may be a single layer having a thickness of from 0.010 or 0.020 or 0.025 inches to 0.035 or 0.040 or 0.050 inches. In another particular embodiment, the cover may consist of an inner cover layer having a thickness of from 0.010 or 0.020 or 0.025 inches to 0.035 or 0.050 inches and an outer cover layer having a thickness of from 0.010 or 0.020 or 0.025 inches to 0.035 or 0.040 inches.

In one embodiment, the cover may be a single layer having a surface hardness of 60 Shore D or greater, or 65 Shore D or greater. In a particular aspect of this embodiment, the cover is formed from a composition having a material hardness of 60 Shore D or greater, or 65 Shore D or greater.

In another particular embodiment, the cover may be a single layer having a thickness of from 0.010 or 0.020 inches to 0.035 or 0.050 inches and formed from an ionomeric composition having a material hardness of from 60 or 62 or 65 Shore D to 65 or 70 or 72 Shore D.

In yet another particular embodiment, the cover is a single layer having a thickness of from 0.010 or 0.025 inches to 0.035 or 0.040 inches and formed from a thermoplastic composition selected from ionomer-, polyurethane-, and polyurea-based compositions having a material hardness of 62 Shore D or less, or less than 62 Shore D, or 60 Shore D or less, or less than 60 Shore D, or 55 Shore D or less, or less than 55 Shore D.

In still another particular embodiment, the cover is a single layer having a thickness of from 0.010 or 0.025 inches to 0.035 or 0.040 inches and formed from a thermosetting polyurethane- or polyurea-based composition having a material hardness of 62 Shore D or less, or less than 62 Shore D, or 60 Shore D or less, or less than 60 Shore D, or 55 Shore D or less, or less than 55 Shore D.

In an alternative embodiment, the cover may comprise an inner cover layer formed from an ionomeric composition and an outer cover layer formed from a thermosetting polyurethane- or polyurea-based composition. The inner cover layer composition may have a material hardness of from 60 or 62 or 65 Shore D to 65 or 70 or 72 Shore D. The inner cover layer may have a thickness within a range having a lower limit of 0.010 or 0.020 or 0.030 inches and an upper limit of 0.035 or 0.040 or 0.050 inches. The outer cover layer composition may have a material hardness of 62 Shore D or less, or less than 62 Shore D, or 60 Shore D or less, or less than 60 Shore D, or 55 Shore D or less, or less than 55 Shore D. The outer cover layer may have a thickness within a range having a lower limit of 0.010 or 0.020 or 0.025 inches and an upper limit of 0.035 or 0.040 or 0.050 inches.

In another embodiment, the cover may comprise an inner cover layer formed from an ionomeric composition and an outer cover layer formed from a thermoplastic composition selected from ionomer-, polyurethane-, and polyurea-based compositions. The inner cover layer composition may have a material hardness of from 60 or 62 or 65 Shore D to 65 or 70 or 72 Shore D. The inner cover layer may have a thickness within a range having a lower limit of 0.010 or 0.020 or 0.030 inches and an upper limit of 0.035 or 0.040 or 0.050 inches. The outer cover layer composition may have a material hardness of 62 Shore D or less, or less than 62 Shore D, or 60 Shore D or less, or less than 60 Shore D, or 55 Shore D or less, or less than 55 Shore D. The outer cover layer may have a thickness within a range having a lower limit of 0.010 or 0.020 or 0.025 inches and an upper limit of 0.035 or 0.040 or 0.050 inches.

In yet another embodiment, the cover is a dual- or multi-layer cover including an inner or intermediate cover layer formed from an ionomeric composition and an outer cover layer formed from a polyurethane- or polyurea-based composition. The ionomeric layer may have a surface hardness of 70 Shore D or less, or 65 Shore D or less, or less than 65 Shore D, or a Shore D hardness of from 50 to 65, or a Shore D hardness of from 57 to 60, or a Shore D hardness of 58, and a thickness within a range having a lower limit of 0.010 or 0.020 or 0.030 inches and an upper limit of 0.045 or 0.080 or 0.120 inches. The outer cover layer may be formed from a castable or reaction injection moldable polyurethane, polyurea, or copolymer or hybrid of polyurethane/polyurea. Such cover material may be thermosetting, but may be thermoplastic in other embodiments. The outer cover layer composition may have a material hardness of 85 Shore C or less, or 45 Shore D or less, or 40 Shore D or less, or from 25 Shore D to 40 Shore D, or from 30 Shore D to 40 Shore D. The outer cover layer may have a surface hardness within a range having a lower limit of 20 or 30 or 35 or 40 Shore D and an upper limit of 52 or 58 or 60 or 65 or 70 or 72 or 75 Shore D. The outer cover layer may have a thickness within a range having a lower limit of 0.010 or 0.015 or 0.025 inches and an upper limit of 0.035 or 0.040 or 0.045 or 0.050 or 0.055 or 0.075 or 0.080 or 0.115 inches.

Once again, in each of these embodiments, one or more of the layers may contain the inventive mixture.

When the at least one layer of inventive mixture is a coating layer(s) or tie layer(s), or moisture barrier layer(s), one or more coating layer may have a combined thickness of from about 0.1 μm to about 100 μm, or from about 2 μm to about 50 μm, or from about 2 μm to about 30 μm. Meanwhile, each coating layer may have a thickness of from about 0.1 μm to about 50 μm, or from about 0.1 μm to about 25 μm, or from about 0.1 μm to about 14 μm, or from about 2 μm to about 9 μm, for example. It is envisioned that a moisture barrier layer or tie layer consisting of the inventive mixture may have any thickness known in the art with respect thereto. in each of these embodiments, one or more of the layers may contain the inventive mixture.

In one embodiment, a core or core layer(s) consisting of the inventive mixture may be covered with a castable thermoset or injection moldable thermoplastic material or any of the other cover materials discussed below. In this embodiment, the core may have a diameter of about 0.5 inches to about 1.64 inches and the cover layer thickness may range from about 0.02 inches to about 0.12 inches.

When not formed from the inventive mixture, any core material known to one of ordinary skill in that art is suitable for use in the golf balls of the invention. Suitable core materials include thermoset materials, such as rubber, styrene butadiene, polybutadiene, isoprene, polyisoprene, trans-isoprene, as well as thermoplastics such as ionomer resins, polyamides or polyesters, and thermoplastic and thermoset polyurethane elastomers.

The core of golf balls of the invention may be solid, semi-solid, hollow, fluid-filled or powder-filled, one-piece or multi-component cores. As used herein, the term “fluid” includes a liquid, a paste, a gel, a gas, or any combination thereof; the term “fluid-filled” includes hollow centers or cores; and the term “semi-solid” refers to a paste, a gel, or the like.

An intermediate layer is sometimes thought of as including any layer(s) disposed between the inner core (or center) and the outer cover of a golf ball, and thus in some embodiments, the intermediate layer may include an outer core layer, a casing layer, or inner cover layer(s). In this regard, one or more intermediate layer may consist of the inventive mixture. An intermediate layer may be used, if desired, with a multilayer cover or a multilayer core, or with both a multilayer cover and a multilayer core. As with the core, the intermediate layer may also include a plurality of layers, wherein one or more of those layers can consist of similar or differing inventive mixtures.

In one non-limiting embodiment, an intermediate layer, consisting of an inventive mixture and having a thickness of about 0.010 inches to about 0.06 inches, is disposed about a core having a diameter ranging from about 1.5 inches to about 1.59 inches. In this embodiment, the core may also consist of an inventive mixture, or, in the alternative, may consist of a conventional core material such as a rubber composition. In some embodiments, the intermediate layer may be covered by a conventional castable thermoset or injection moldable thermoplastic material or of any other cover materials discussed herein or as is otherwise known in the art. Alternatively, the cover may consist of an inventive mixture. Regardless, the cover in this embodiment may have a thickness of about 0.02 inches to about 0.05 inches and may be any of clear, transparent and colorless; or clear, transparent colored; or translucent, as long as the color appearance of the intermediate layer is at least partially visible through the cover.

In another embodiment, an intermediate layer is covered by an inner cover layer, and at least one of the intermediate layer and inner cover layer consists of an inventive mixture. In one such embodiment, the intermediate layer is formed from a conventional golf ball composition whereas the inner cover layer consists of an inventive mixture in order to target or produce certain desired performance results. Conversely, embodiments are also envisioned wherein the intermediate layer consists of an inventive mixture while the inner cover layer is formed from a conventional material that is transparent or at least partially translucent. In another embodiment, both the intermediate layer and inner cover layer each consist of an inventive mixture. Meanwhile, the core center (innermost core component of the golf ball) may be formed from an inventive mixture or, in other embodiments, may be formed of any of the conventional core materials discussed herein, including castable thermoset materials or injection moldable thermoplastic materials or as otherwise known in the art. An outer core layer having a thickness of about 0.125 inches to about 0.500 inches may surround the center to form the core. A casing layer, having a thickness of about 0.010 inches to about 0.06 inches and being formed from an inventive mixture, or alternatively a castable thermoset material or an injection moldable thermoplastic material, may be disposed between the core and intermediate layer.

Meanwhile, an outer cover layer of this golf ball, which preferably has a thickness of about 0.02 inches to about 0.05 inches, may be formed from an inventive mixture, or alternatively castable thermoset material or an injection moldable thermoplastic material or other suitable cover materials discussed below and as otherwise known in the art, as long as the color appearance of any inner layers containing the inventive mixture are at least partially visible through that outer cover. In an alternative embodiment, both the inner cover layer and outer cover layer consist of an inventive mixture. In a different embodiment, only the outermost cover layer consists of the inventive mixture.

When not formed from an inventive mixture, intermediate layer(s) may be formed, at least in part, from one or more homopolymeric or copolymeric materials, such as ionomers, primarily or fully non-ionomeric thermoplastic materials, vinyl resins, polyolefins, polyurethanes, polyureas, polyamides, acrylic resins and blends thereof, olefinic thermoplastic rubbers, block copolymers of styrene and butadiene, isoprene or ethylene-butylene rubber, copoly(ether-amide), polyphenylene oxide resins or blends thereof, and thermoplastic polyesters.

The cover provides the interface between the ball and a club. Properties that are desirable for the cover are good moldability, high moisture resistance, high abrasion resistance, high impact resistance, high tear strength, high resilience, and good mold release, among others. The cover layer may consist of an inventive mixture. When not formed from an inventive mixture, the cover may alternatively be formed from one or more homopolymeric or copolymeric materials as discussed in or otherwise known in the golf ball art as possible cover materials.

In a different embodiment, a golf ball of the invention comprises a subassembly, an inner cover layer disposed about the subassembly, and an outer cover layer disposed about the inner cover layer, wherein at least one of the inner cover layer and outer cover layer is the at least one layer. In such embodiments, the subassembly may have any known construction such as a single core, a dual core (center surrounded by outer core layer), or core having any number of layers, or a core surrounded by any number of intermediate layers.

Embodiments are envisioned wherein a golf ball of the invention includes two or more layers wherein at least two of the layers consist of differing inventive mixtures. In this regard, two given inventive mixtures may differ for example with respect to the particular layer composition, the particular trigonal bipyramidal coordination complex composition, or both.

For example, two given layer compositions may differ with respect to the type of polymer selected (e.g., rubber based, versus ionomer, versus polyurethane, versus polyurea, versus polyurethane/polyurea hybid, etc.), and/or with respect to the amount of layer composition included in the mixture, and/or with respect to the type or amount of additives/fillers incorporated in each layer composition.

In turn, two given trigonal bipyramidal coordination complex compositions may differ with respect to the specific formulation of trigonal bipyramidally coordinated metal cations, and/or with respect to the type or amount of additives/fillers incorporated therein, etc.

In some such embodiments, first and second differing inventive layers may be adjacent. Having such first and second differing inventive layers will generally improve adhesion between same. In other embodiments, the first and second differing layers may have at least a third layer disposed there between. In an embodiment wherein at least a third layer is disposed between first and second differing layers, that third layer may contain conventional golf ball materials, or alternatively, may contain an inventive mixture that further differs from each of the inventive mixtures of the first and second differing inventive layers. In alternative embodiments, the third layer may contain an inventive mixture that is more similar to the inventive mixture of one of the first and second differing layers than to the other.

In one embodiment, a golf ball of the invention may comprise a subassembly having an outer surface, about which a coating layer is disposed, wherein the outer surface contains a first inventive mixture and the coating layer contains a second inventive mixture that differs from the first inventive mixture. In such an embodiment, the subassembly may have any known construction such as a single core, a dual core (center surrounded by outer core layer), or core having any number of layers, or a core surrounded by any number of intermediate layers and cover layers. And the first inventive mixture may be incorporated in the outermost golf ball layer of the subassembly that is adjacent to the coating layer.

In another embodiment, a golf ball of the invention may comprise a subassembly having an outer surface, with two or more coating layers disposed about the outer surface. In this embodiment, each coating layer as well as the outer surface may consist of a different inventive mixture.

Accordingly, differing inventive mixtures may be preselected and coordinated in golf ball constructions to target a wide range of desirable playing characteristics and overall golf ball appearances without sacrificing desired physical properties or playing characteristics.

The at least one layer may be implemented within and/or between cores, intermediate layers, cover layers, and even coating layers of golf balls of the invention. The at least one layer may also be used as a tie layer to improve adhesion between two conventional golf ball layers or even moisture barrier layer to prevent or reduce moisture penetration into inner layers.

Meanwhile, conventional golf ball compositions may also be used in golf balls of the invention, such as in an innermost layer comprised of a conventional rubber-containing inner core, wherein the base rubber may be selected from polybutadiene rubber, polyisoprene rubber, natural rubber, ethylene-propylene rubber, ethylene-propylene diene rubber, styrene-butadiene rubber, and combinations of two or more thereof. A preferred base rubber is polybutadiene. Another preferred base rubber is polybutadiene optionally mixed with one or more elastomers selected from polyisoprene rubber, natural rubber, ethylene propylene rubber, ethylene propylene diene rubber, styrene-butadiene rubber, polystyrene elastomers, polyethylene elastomers, polyurethane elastomers, polyurea elastomers, metallocene-catalyzed elastomers, and plastomers.

Suitable curing processes include, for example, peroxide curing, sulfur curing, radiation, and combinations thereof. In one embodiment, the base rubber is peroxide cured. Organic peroxides suitable as free-radical initiators include, for example, dicumyl peroxide; n-butyl-4,4-di(t-butylperoxy) valerate; 1,1-di(t-butylperoxy)3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. Peroxide free-radical initiators are generally present in the rubber compositions in an amount within the range of 0.05 to 15 parts, preferably 0.1 to 10 parts, and more preferably 0.25 to 6 parts by weight per 100 parts of the base rubber. Cross-linking agents are used to cross-link at least a portion of the polymer chains in the composition. Suitable cross-linking agents include, for example, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. Particularly suitable metal salts include, for example, one or more metal salts of acrylates, diacrylates, methacrylates, and dimethacrylates, wherein the metal is selected from magnesium, calcium, zinc, aluminum, lithium, and nickel. In a particular embodiment, the cross-linking agent is selected from zinc salts of acrylates, diacrylates, methacrylates, and dimethacrylates. When the cross-linking agent is zinc diacrylate and/or zinc dimethacrylate, the agent typically is included in the rubber composition in an amount within the range of 1 to 60 parts, preferably 5 to 50 parts, and more preferably 10 to 40 parts, by weight per 100 parts of the base rubber.

In a preferred embodiment, the cross-linking agent used in the rubber composition of the core and epoxy composition of the intermediate layer and/or cover layer is zinc diacrylate (“ZDA”). Adding the ZDA curing agent to the rubber composition makes the core harder and improves the resiliency/CoR of the ball. Adding the same ZDA curing agent epoxy composition makes the intermediate and cover layers harder and more rigid. As a result, the overall durability, toughness, and impact strength of the ball is improved.

Sulfur and sulfur-based curing agents with optional accelerators may be used in combination with or in replacement of the peroxide initiators to cross-link the base rubber. High energy radiation sources capable of generating free-radicals may also be used to cross-link the base rubber. Suitable examples of such radiation sources include, for example, electron beams, ultra-violet radiation, gamma radiation, X-ray radiation, infrared radiation, heat, and combinations thereof.

The rubber compositions may also contain “soft and fast” agents such as a halogenated organosulfur, organic disulfide, or inorganic disulfide compound. Particularly suitable halogenated organosulfur compounds include, but are not limited to, halogenated thiophenols. Preferred organic sulfur compounds include, but not limited to, pentachlorothiophenol (“PCTP”) and a salt of PCTP. A preferred salt of PCTP is ZnPCTP. A suitable PCTP is sold by the Struktol Company (Stow, Ohio) under the tradename, A 95. ZnPCTP is commercially available from eChinaChem Inc. (San Francisco, Calif.). These compounds also may function as cis-to-trans catalysts to convert some cis-1,4 bonds in the polybutadiene to trans-1,4 bonds. Peroxide free-radical initiators are generally present in the rubber compositions in an amount within the range of 0.05 to 10 parts and preferably 0.1 to 5 parts. Antioxidants also may be added to the rubber compositions to prevent the breakdown of the elastomers. Other ingredients such as accelerators (for example, tetra methylthiurams), processing aids, processing oils, dyes and pigments, wetting agents, surfactants, plasticizers, as well as other additives known in the art may be added to the composition. Generally, the fillers and other additives are present in the rubber composition in an amount within the range of 1 to 70 parts by weight per 100 parts of the base rubber. The core may be formed by mixing and forming the rubber composition using conventional techniques. Of course, embodiments are also envisioned wherein outer layers comprise such rubber-based compositions

However, core layers, intermediate/casing layers, and cover layers may additionally or alternatively be formed from other conventional materials such as an ionomeric material including ionomeric polymers, preferably highly-neutralized ionomers (HNP). In another embodiment, the intermediate layer of the golf ball is formed from an HNP material or a blend of HNP materials. The acid moieties of the HNP's, typically ethylene-based ionomers, are preferably neutralized greater than about 70%, more preferably greater than about 90%, and most preferably at least about 100%. The HNP's can be also be blended with a second polymer component, which, if containing an acid group, may also be neutralized. The second polymer component, which may be partially or fully neutralized, preferably comprises ionomeric copolymers and terpolymers, ionomer precursors, thermoplastics, polyamides, polycarbonates, polyesters, polyurethanes, polyureas, polyurethane/urea hybrids, thermoplastic elastomers, polybutadiene rubber, balata, metallocene-catalyzed polymers (grafted and non-grafted), single-site polymers, high-crystalline acid polymers, cationic ionomers, and the like. HNP polymers typically have a material hardness of between about 20 and about 80 Shore D, and a flexural modulus of between about 3,000 psi and about 200,000 psi.

Non-limiting examples of suitable ionomers include partially neutralized ionomers, blends of two or more partially neutralized ionomers, highly neutralized ionomers, blends of two or more highly neutralized ionomers, and blends of one or more partially neutralized ionomers with one or more highly neutralized ionomers. Methods of preparing ionomers are well known, and are disclosed, for example, in U.S. Pat. No. 3,264,272, the entire disclosure of which is hereby incorporated herein by reference. The acid copolymer can be a direct copolymer wherein the polymer is polymerized by adding all monomers simultaneously, as disclosed, for example, in U.S. Pat. No. 4,351,931, the entire disclosure of which is hereby incorporated herein by reference. Alternatively, the acid copolymer can be a graft copolymer wherein a monomer is grafted onto an existing polymer, as disclosed, for example, in U.S. Patent Application Publication No. 2002/0013413, the entire disclosure of which is hereby incorporated herein by reference.

Examples of suitable partially neutralized acid polymers include, but are not limited to, Surlyn® ionomers, commercially available from E. I. du Pont de Nemours and Company; AClyn® ionomers, commercially available from Honeywell International Inc.; and Iotek® ionomers, commercially available from Exxon Mobil Chemical Company. Some suitable examples of highly neutralized ionomers (HNP) are DuPont® HPF 1000 and DuPont® HPF 2000, ionomeric materials commercially available from E. I. du Pont de Nemours and Company. In some embodiments, very low modulus ionomer- (“VLMI-”) type ethylene-acid polymers are particularly suitable for forming the HNP, such as Surlyn® 6320, Surlyn® 8120, Surlyn® 8320, and Surlyn® 9320, commercially available from E. I. du Pont de Nemours and Company.

It is meanwhile envisioned that in some embodiments/golf ball constructions, it may be beneficial to also include at least one layer formed from or blended with a conventional isocyante-based material. The following conventional compositions as known in the art may be incorporated to achieve particular desired golf ball characteristics:

(1) Polyurethanes, such as those prepared from polyols and diisocyanates or polyisocyanates and/or their prepolymers, and those disclosed in U.S. Pat. Nos. 5,334,673 and 6,506,851;

(2) Polyureas, such as those disclosed in U.S. Pat. Nos. 5,484,870 and 6,835,794; and

(3) Polyurethane/urea hybrids, blends or copolymers comprising urethane and urea segments such as those disclosed in U.S. Pat. No. 8,506,424.

Suitable polyurethane compositions comprise a reaction product of at least one polyisocyanate and at least one curing agent. The curing agent can include, for example, one or more polyols. The polyisocyanate can be combined with one or more polyols to form a prepolymer, which is then combined with the at least one curing agent. Thus, the polyols described herein are suitable for use in one or both components of the polyurethane material, i.e., as part of a prepolymer and in the curing agent. Suitable polyurethanes are described in U.S. Pat. No. 7,331,878, which is incorporated herein in its entirety by reference.

In general, polyurea compositions contain urea linkages formed by reacting an isocyanate group (—N═C═O) with an amine group (NH or NH₂). The chain length of the polyurea prepolymer is extended by reacting the prepolymer with an amine curing agent. The resulting polyurea has elastomeric properties, because of its “hard” and “soft” segments, which are covalently bonded together. The soft, amorphous, low-melting point segments, which are formed from the polyamines, are relatively flexible and mobile, while the hard, high-melting point segments, which are formed from the isocyanate and chain extenders, are relatively stiff and immobile. The phase separation of the hard and soft segments provides the polyurea with its elastomeric resiliency. The polyurea composition contains urea linkages having the following general structure:

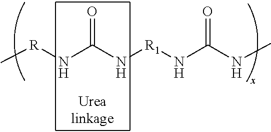

where x is the chain length, i.e., about 1 or greater, and R and R₁ are straight chain or branched hydrocarbon chains having about 1 to about 20 carbon atoms.

A polyurea/polyurethane hybrid composition is produced when the polyurea prepolymer (as described above) is chain-extended using a hydroxyl-terminated curing agent. Any excess isocyanate groups in the prepolymer will react with the hydroxyl groups in the curing agent and create urethane linkages. That is, a polyurea/polyurethane hybrid composition is produced.

In a preferred embodiment, a pure polyurea composition, as described above, is prepared. That is, the composition contains only urea linkages. An amine-terminated curing agent is used in the reaction to produce the pure polyurea composition. However, it should be understood that a polyurea/polyurethane hybrid composition also may be prepared in accordance with this invention as discussed above. Such a hybrid composition can be formed if the polyurea prepolymer is cured with a hydroxyl-terminated curing agent. Any excess isocyanate in the polyurea prepolymer reacts with the hydroxyl groups in the curing agent and forms urethane linkages. The resulting polyurea/polyurethane hybrid composition contains both urea and urethane linkages. The general structure of a urethane linkage is shown below:

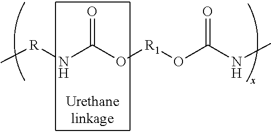

where x is the chain length, i.e., about 1 or greater, and R and R₁ are straight chain or branched hydrocarbon chains having about 1 to about 20 carbon atoms.

There are two basic techniques that can be used to make the polyurea and polyurea/urethane compositions of this invention: a) one-shot technique, and b) prepolymer technique. In the one-shot technique, the isocyanate blend, polyamine, and hydroxyl and/or amine-terminated curing agent are reacted in one step. On the other hand, the prepolymer technique involves a first reaction between the isocyanate blend and polyamine to produce a polyurea prepolymer, and a subsequent reaction between the prepolymer and hydroxyl and/or amine-terminated curing agent. As a result of the reaction between the isocyanate and polyamine compounds, there will be some unreacted NCO groups in the polyurea prepolymer. The prepolymer should have less than 14% unreacted NCO groups. Preferably, the prepolymer has no greater than 8.5% unreacted NCO groups, more preferably from 2.5% to 8%, and most preferably from 5.0% to 8.0% unreacted NCO groups. As the weight percent of unreacted isocyanate groups increases, the hardness of the composition also generally increases.

Either the one-shot or prepolymer method may be employed to produce the polyurea and polyurea/urethane compositions of the invention; however, the prepolymer technique is preferred because it provides better control of the chemical reaction. The prepolymer method provides a more homogeneous mixture resulting in a more consistent polymer composition. The one-shot method results in a mixture that is inhomogeneous (more random) and affords the manufacturer less control over the molecular structure of the resultant composition.

In the casting process, the polyurea and polyurea/urethane compositions can be formed by chain-extending the polyurea prepolymer with a single curing agent or blend of curing agents as described further below. The compositions of the present invention may be selected from among both castable thermoplastic and thermoset materials. Thermoplastic polyurea compositions are typically formed by reacting the isocyanate blend and polyamines at a 1:1 stoichiometric ratio. Thermoset compositions, on the other hand, are cross-linked polymers and are typically produced from the reaction of the isocyanate blend and polyamines at normally a 1.05:1 stoichiometric ratio. In general, thermoset polyurea compositions are easier to prepare than thermoplastic polyureas.

The polyurea prepolymer can be chain-extended by reacting it with a single curing agent or blend of curing agents (chain-extenders). In general, the prepolymer can be reacted with hydroxyl-terminated curing agents, amine-terminated curing agents, or mixtures thereof. The curing agents extend the chain length of the prepolymer and build-up its molecular weight. Normally, the prepolymer and curing agent are mixed so the isocyanate groups and hydroxyl or amine groups are mixed at a 1.05:1.00 stoichiometric ratio.

A catalyst may be employed to promote the reaction between the isocyanate and polyamine compounds for producing the prepolymer or between prepolymer and curing agent during the chain-extending step. Preferably, the catalyst is added to the reactants before producing the prepolymer. Suitable catalysts include, but are not limited to, bismuth catalyst; zinc octoate; stannous octoate; tin catalysts such as bis-butyltin dilaurate, bis-butyltin diacetate, stannous octoate; tin (II) chloride, tin (IV) chloride, bis-butyltin dimethoxide, dimethyl-bis[1-oxonedecyl)oxy]stannane, di-n-octyltin bis-isooctyl mercaptoacetate; amine catalysts such as triethylenediamine, triethylamine, and tributylamine; organic acids such as oleic acid and acetic acid; delayed catalysts; and mixtures thereof. The catalyst is preferably added in an amount sufficient to catalyze the reaction of the components in the reactive mixture. In one embodiment, the catalyst is present in an amount from about 0.001 percent to about 1 percent, and preferably 0.1 to 0.5 percent, by weight of the composition.

The hydroxyl chain-extending (curing) agents are preferably selected from the group consisting of ethylene glycol; diethylene glycol; polyethylene glycol; propylene glycol; 2-methyl-1,3-propanediol; 2-methyl-1,4-butanediol; monoethanolamine; diethanolamine; triethanolamine; monoisopropanolamine; diisopropanolamine; dipropylene glycol; polypropylene glycol; 1,2-butanediol; 1,3-butanediol; 1,4-butanediol; 2,3-butanediol; 2,3-dimethyl-2,3-butanediol; trimethylolpropane; cyclohexyldimethylol; triisopropanolamine; N,N,N′,N′-tetra-(2-hydroxypropyl)-ethylene diamine; diethylene glycol bis-(aminopropyl) ether; 1,5-pentanediol; 1,6-hexanediol; 1,3-bis-(2-hydroxyethoxy) cyclohexane; 1,4-cyclohexyldimethylol; 1,3-bis-[2-(2-hydroxyethoxy)ethoxy]cyclohexane; 1,3-bis-{2-[2-(2-hydroxyethoxy) ethoxy]ethoxy}cyclohexane; trimethylolpropane; polytetramethylene ether glycol (PTMEG), preferably having a molecular weight from about 250 to about 3900; and mixtures thereof.

Suitable amine chain-extending (curing) agents that can be used in chain-extending the polyurea prepolymer of this invention include, but are not limited to, unsaturated diamines such as 4,4′-diamino-diphenylmethane (i.e., 4,4′-methylene-dianiline or “MDA”), m-phenylenediamine, p-phenylenediamine, 1,2- or 1,4-bis(sec-butylamino)benzene, 3,5-diethyl-(2,4- or 2,6-) toluenediamine or “DETDA”, 3,5-dimethylthio-(2,4- or 2,6-)toluenediamine, 3,5-diethylthio-(2,4- or 2,6-)toluenediamine, 3,3′-dimethyl-4,4′-diamino-diphenylmethane, 3,3′-diethyl-5,5′-dimethyl4,4′-diamino-diphenylmethane (i.e., 4,4′-methylene-bis(2-ethyl-6-methyl-benezeneamine)), 3,3′-dichloro-4,4′-diamino-diphenylmethane (i.e., 4,4′-methylene-bis(2-chloroaniline) or “MOCA”), 3,3′,5,5′-tetraethyl-4,4′-diamino-diphenylmethane (i.e., 4,4′-methylene-bis(2,6-diethylaniline), 2,2′-dichloro-3,3′,5,5′-tetraethyl-4,4′-diamino-diphenylmethane (i.e., 4,4′-methylene-bis(3-chloro-2,6-diethyleneaniline) or “MCDEA”), 3,3′-diethyl-5,5′-dichloro-4,4′-diamino-diphenylmethane, or “MDEA”), 3,3′-dichloro-2,2′,6,6′-tetraethyl-4,4′-diamino-diphenylmethane, 3,3′-dichloro-4,4′-diamino-diphenylmethane, 4,4′-methylene-bis(2,3-dichloroaniline) (i.e., 2,2′,3,3′-tetrachloro-4,4′-diamino-diphenylmethane or “MDCA”), 4,4′-bis(sec-butylamino)-diphenylmethane, N,N′-dialkylamino-diphenylmethane, trimethyleneglycol-di(p-aminobenzoate), polyethyleneglycol-di(p-aminobenzoate), polytetramethyleneglycol-di(p-aminobenzoate); saturated diamines such as ethylene diamine, 1,3-propylene diamine, 2-methyl-pentamethylene diamine, hexamethylene diamine, 2,2,4- and 2,4,4-trimethyl-1,6-hexane diamine, imino-bis(propylamine), imido-bis(propylamine), methylimino-bis(propylamine) (i.e., N-(3-aminopropyl)-N-methyl-1,3-propanediamine), 1,4-bis(3-aminopropoxy)butane (i.e., 3,3′-[1,4-butanediylbis-(oxy)bis]-1-propanamine), diethyleneglycol-bis(propylamine) (i.e., diethyleneglycol-di(aminopropyl)ether), 4,7,10-trioxatridecane-1,13-diamine, 1-methyl-2,6-diamino-cyclohexane, 1,4-diamino-cyclohexane, poly(oxyethylene-oxypropylene) diamines, 1,3- or 1,4-bis(methylamino)-cyclohexane, isophorone diamine, 1,2- or 1,4-bis(sec-butylamino)-cyclohexane, N,N′-diisopropyl-isophorone diamine, 4,4′-diamino-dicyclohexylmethane, 3,3′-dimethyl-4,4′-diamino-dicyclohexylmethane, 3,3′-dichloro-4,4′-diamino-dicyclohexylmethane, N,N′-dialkylamino-dicyclohexylmethane, polyoxyethylene diamines, 3,3′-diethyl-5,5′-dimethyl-4,4′-diamino-dicyclohexylmethane, polyoxypropylene diamines, 3,3′-diethyl-5,5′-dichloro-4,4′-diamino-dicyclohexylmethane, polytetramethylene ether diamines, 3,3′,5,5 ‘-tetraethyl-4,4’-diamino-dicyclohexylmethane (i.e., 4,4′-methylene-bis(2,6-diethylaminocyclohexane)), 3,3′-dichloro-4,4′-diamino-dicyclohexylmethane, 2,2′-dichloro-3,3′,5,5′-tetraethyl-4,4′-diamino-dicyclohexylmethane, (ethylene oxide)-capped polyoxypropylene ether diamines, 2,2′,3,3′-tetrachloro-4,4′-diamino-dicyclohexylmethane, 4,4′-bis(sec-butylamino)-dicyclohexylmethane; triamines such as diethylene triamine, dipropylene triamine, (propylene oxide)-based triamines (i.e., polyoxypropylene triamines), N-(2-aminoethyl)-1,3-propylenediamine (i.e., N₃-amine), glycerin-based triamines, (all saturated); tetramines such as N,N′-bis(3-aminopropyl)ethylene diamine (i.e., N₄-amine) (both saturated), triethylene tetramine; and other polyamines such as tetraethylene pentamine (also saturated). One suitable amine-terminated chain-extending agent is Ethacure 300™ (dimethylthiotoluenediamine or a mixture of 2,6-diamino-3,5-dimethylthiotoluene and 2,4-diamino-3,5-dimethylthiotoluene.) The amine curing agents used as chain extenders normally have a cyclic structure and a low molecular weight (250 or less).

When the polyurea prepolymer is reacted with amine-terminated curing agents during the chain-extending step, as described above, the resulting composition is essentially a pure polyurea composition. On the other hand, when the polyurea prepolymer is reacted with a hydroxyl-terminated curing agent during the chain-extending step, any excess isocyanate groups in the prepolymer will react with the hydroxyl groups in the curing agent and create urethane linkages to form a polyurea/urethane hybrid.

This chain-extending step, which occurs when the polyurea prepolymer is reacted with hydroxyl curing agents, amine curing agents, or mixtures thereof, builds-up the molecular weight and extends the chain length of the prepolymer. When the polyurea prepolymer is reacted with amine curing agents, a polyurea composition having urea linkages is produced. When the polyurea prepolymer is reacted with hydroxyl curing agents, a polyurea/urethane hybrid composition containing both urea and urethane linkages is produced. The polyurea/urethane hybrid composition is distinct from the pure polyurea composition. The concentration of urea and urethane linkages in the hybrid composition may vary. In general, the hybrid composition may contain a mixture of about 10 to 90% urea and about 90 to 10% urethane linkages. The resulting polyurea or polyurea/urethane hybrid composition has elastomeric properties based on phase separation of the soft and hard segments. The soft segments, which are formed from the polyamine reactants, are generally flexible and mobile, while the hard segments, which are formed from the isocyanates and chain extenders, are generally stiff and immobile.

In an alternative embodiment, the cover layer may comprise a conventional polyurethane or polyurethane/urea hybrid composition. In general, polyurethane compositions contain urethane linkages formed by reacting an isocyanate group (—N═C═O) with a hydroxyl group (OH). The polyurethanes are produced by the reaction of a multi-functional isocyanate (NCO—R—NCO) with a long-chain polyol having terminal hydroxyl groups (OH—OH) in the presence of a catalyst and other additives. The chain length of the polyurethane prepolymer is extended by reacting it with short-chain diols (OH—R′—OH). The resulting polyurethane has elastomeric properties because of its “hard” and “soft” segments, which are covalently bonded together. This phase separation occurs because the mainly non-polar, low melting soft segments are incompatible with the polar, high melting hard segments. The hard segments, which are formed by the reaction of the diisocyanate and low molecular weight chain-extending diol, are relatively stiff and immobile. The soft segments, which are formed by the reaction of the diisocyanate and long chain diol, are relatively flexible and mobile. Because the hard segments are covalently coupled to the soft segments, they inhibit plastic flow of the polymer chains, thus creating elastomeric resiliency.

Suitable isocyanate compounds that can be used to prepare the polyurethane or polyurethane/urea hybrid material are described above. These isocyanate compounds are able to react with the hydroxyl or amine compounds and form a durable and tough polymer having a high melting point. The resulting polyurethane generally has good mechanical strength and cut/shear-resistance. In addition, the polyurethane composition has good light and thermal-stability.

When forming a polyurethane prepolymer, any suitable polyol may be reacted with the above-described isocyanate blends in accordance with this invention. Exemplary polyols include, but are not limited to, polyether polyols, hydroxy-terminated polybutadiene (including partially/fully hydrogenated derivatives), polyester polyols, polycaprolactone polyols, and polycarbonate polyols. In one preferred embodiment, the polyol includes polyether polyol. Examples include, but are not limited to, polytetramethylene ether glycol (PTMEG), polyethylene propylene glycol, polyoxypropylene glycol, and mixtures thereof. The hydrocarbon chain can have saturated or unsaturated bonds and substituted or unsubstituted aromatic and cyclic groups. Preferably, the polyol of the present invention includes PTMEG.

In another embodiment, polyester polyols are included in the polyurethane material. Suitable polyester polyols include, but are not limited to, polyethylene adipate glycol; polybutylene adipate glycol; polyethylene propylene adipate glycol; o-phthalate-1,6-hexanediol; poly(hexamethylene adipate) glycol; and mixtures thereof. The hydrocarbon chain can have saturated or unsaturated bonds, or substituted or unsubstituted aromatic and cyclic groups. In still another embodiment, polycaprolactone polyols are included in the materials of the invention. Suitable polycaprolactone polyols include, but are not limited to: 1,6-hexanediol-initiated polycaprolactone, diethylene glycol initiated polycaprolactone, trimethylol propane initiated polycaprolactone, neopentyl glycol initiated polycaprolactone, 1,4-butanediol-initiated polycaprolactone, and mixtures thereof. The hydrocarbon chain can have saturated or unsaturated bonds, or substituted or unsubstituted aromatic and cyclic groups. In yet another embodiment, polycarbonate polyols are included in the polyurethane material of the invention. Suitable polycarbonates include, but are not limited to, polyphthalate carbonate and poly(hexamethylene carbonate) glycol. The hydrocarbon chain can have saturated or unsaturated bonds, or substituted or unsubstituted aromatic and cyclic groups. In one embodiment, the molecular weight of the polyol is from about 200 to about 4000.

In a manner similar to making the above-described polyurea compositions, there are two basic techniques that can be used to make the polyurethane compositions of this invention: a) one-shot technique, and b) prepolymer technique. In the one-shot technique, the isocyanate blend, polyol, and hydroxyl-terminated and/or amine-terminated chain-extender (curing agent) are reacted in one step. On the other hand, the prepolymer technique involves a first reaction between the isocyanate blend and polyol compounds to produce a polyurethane prepolymer, and a subsequent reaction between the prepolymer and hydroxyl-terminated and/or amine-terminated chain-extender. As a result of the reaction between the isocyanate and polyol compounds, there will be some unreacted NCO groups in the polyurethane prepolymer. The prepolymer should have less than 14% unreacted NCO groups. Preferably, the prepolymer has no greater than 8.5% unreacted NCO groups, more preferably from 2.5% to 8%, and most preferably from 5.0% to 8.0% unreacted NCO groups. As the weight percent of unreacted isocyanate groups increases, the hardness of the composition also generally increases.

Either the one-shot or prepolymer method may be employed to produce the polyurethane compositions of the invention. In one embodiment, the one-shot method is used, wherein the isocyanate compound is added to a reaction vessel and then a curative mixture comprising the polyol and curing agent is added to the reaction vessel. The components are mixed together so that the molar ratio of isocyanate groups to hydroxyl groups is in the range of about 1.01:1.00 to about 1.10:1.00. Preferably, the molar ratio is greater than or equal to 1.05:1.00. For example, the molar ratio can be in the range of 1.05:1.00 to 1.10:1.00. In a second embodiment, the prepolymer method is used. In general, the prepolymer technique is preferred because it provides better control of the chemical reaction. The prepolymer method provides a more homogeneous mixture resulting in a more consistent polymer composition. The one-shot method results in a mixture that is inhomogeneous (more random) and affords the manufacturer less control over the molecular structure of the resultant composition.

The polyurethane compositions can be formed by chain-extending the polyurethane prepolymer with a single curing agent (chain-extender) or blend of curing agents (chain-extenders) as described further below. The compositions of the present invention may be selected from among both castable thermoplastic and thermoset polyurethanes. Thermoplastic polyurethane compositions are typically formed by reacting the isocyanate blend and polyols at a 1:1 stoichiometric ratio. Thermoset compositions, on the other hand, are cross-linked polymers and are typically produced from the reaction of the isocyanate blend and polyols at normally a 1.05:1 stoichiometric ratio. In general, thermoset polyurethane compositions are easier to prepare than thermoplastic polyurethanes.

As discussed above, the polyurethane prepolymer can be chain-extended by reacting it with a single chain-extender or blend of chain-extenders. In general, the prepolymer can be reacted with hydroxyl-terminated curing agents, amine-terminated curing agents, and mixtures thereof. The curing agents extend the chain length of the prepolymer and build-up its molecular weight. Normally, the prepolymer and curing agent are mixed so the isocyanate groups and hydroxyl or amine groups are mixed at a 1.05:1.00 stoichiometric ratio.

A catalyst may be employed to promote the reaction between the isocyanate and polyol compounds for producing the polyurethane prepolymer or between the polyurethane prepolymer and chain-extender during the chain-extending step. Preferably, the catalyst is added to the reactants before producing the polyurethane prepolymer. Suitable catalysts include, but are not limited to, the catalysts described above for making the polyurea prepolymer. The catalyst is preferably added in an amount sufficient to catalyze the reaction of the components in the reactive mixture. In one embodiment, the catalyst is present in an amount from about 0.001 percent to about 1 percent, and preferably 0.1 to 0.5 percent, by weight of the composition.

Suitable hydroxyl chain-extending (curing) agents and amine chain-extending (curing) agents include, but are not limited to, the curing agents described above for making the polyurea and polyurea/urethane hybrid compositions. When the polyurethane prepolymer is reacted with hydroxyl-terminated curing agents during the chain-extending step, as described above, the resulting polyurethane composition contains urethane linkages. On the other hand, when the polyurethane prepolymer is reacted with amine-terminated curing agents during the chain-extending step, any excess isocyanate groups in the prepolymer will react with the amine groups in the curing agent. The resulting polyurethane composition contains urethane and urea linkages and may be referred to as a polyurethane/urea hybrid. The concentration of urethane and urea linkages in the hybrid composition may vary. In general, the hybrid composition may contain a mixture of about 10 to 90% urethane and about 90 to 10% urea linkages.

Those layers of golf balls of the invention comprising conventional thermoplastic or thermoset materials may likewise be formed using a variety of conventional application techniques such as compression molding, flip molding, injection molding, retractable pin injection molding, reaction injection molding (RIM), liquid injection molding (LIM), casting, vacuum forming, powder coating, flow coating, spin coating, dipping, spraying, and the like. Conventionally, compression molding and injection molding are applied to thermoplastic materials, whereas RIM, liquid injection molding, and casting are employed on thermoset materials. These and other manufacture methods are disclosed in U.S. Pat. Nos. 6,207,784 and 5,484,870, the disclosures of which are incorporated herein by reference in their entireties.

A method of injection molding using a split vent pin can be found in co-pending U.S. Pat. No. 6,877,974, filed Dec. 22, 2000, entitled “Split Vent Pin for Injection Molding.” Examples of retractable pin injection molding may be found in U.S. Pat. Nos. 6,129,881; 6,235,230; and 6,379,138. These molding references are incorporated in their entirety by reference herein. In addition, a chilled chamber, i.e., a cooling jacket, such as the one disclosed in U.S. Pat. No. 6,936,205, filed Nov. 22, 2000, entitled “Method of Making Golf Balls” may be used to cool the compositions of the invention when casting, which also allows for a higher loading of catalyst into the system.

Castable reactive liquid polyurethanes and polyurea materials may be applied over the inner ball using a variety of application techniques such as casting, injection molding spraying, compression molding, dipping, spin coating, or flow coating methods that are well known in the art. In one embodiment, the castable reactive polyurethanes and polyurea material is formed over the core using a combination of casting and compression molding. Conventionally, compression molding and injection molding are applied to thermoplastic cover materials, whereas RIM, liquid injection molding, and casting are employed on thermoset cover materials.

U.S. Pat. No. 5,733,428, the entire disclosure of which is hereby incorporated by reference, discloses a method for forming a polyurethane cover on a golf ball core. Because this method relates to the use of both casting thermosetting and thermoplastic material as the golf ball cover, wherein the cover is formed around the core by mixing and introducing the material in mold halves, the polyurea compositions may also be used employing the same casting process.

For example, once a polyurea composition is mixed, an exothermic reaction commences and continues until the material is solidified around the core. It is important that the viscosity be measured over time, so that the subsequent steps of filling each mold half, introducing the core into one half and closing the mold can be properly timed for accomplishing centering of the core cover halves fusion and achieving overall uniformity. A suitable viscosity range of the curing urea mix for introducing cores into the mold halves is determined to be approximately between about 2,000 cP and about 30,000 cP, or within a range of about 8,000 cP to about 15,000 cP.

To start the cover formation, mixing of the prepolymer and curative is accomplished in a motorized mixer inside a mixing head by feeding through lines metered amounts of curative and prepolymer. Top preheated mold halves are filled and placed in fixture units using centering pins moving into apertures in each mold. At a later time, the cavity of a bottom mold half, or the cavities of a series of bottom mold halves, is filled with similar mixture amounts as used for the top mold halves. After the reacting materials have resided in top mold halves for about 40 to about 100 seconds, preferably for about 70 to about 80 seconds, a core is lowered at a controlled speed into the gelling reacting mixture.

A ball cup holds the shell through reduced pressure (or partial vacuum). Upon location of the core in the halves of the mold after gelling for about 4 to about 12 seconds, the vacuum is released allowing the core to be released. In one embodiment, the vacuum is released allowing the core to be released after about 5 seconds to 10 seconds. The mold halves, with core and solidified cover half thereon, are removed from the centering fixture unit, inverted and mated with second mold halves which, at an appropriate time earlier, have had a selected quantity of reacting polyurea prepolymer and curing agent introduced therein to commence gelling.

Similarly, U.S. Pat. No. 5,006,297 and U.S. Pat. No. 5,334,673 both also disclose suitable molding techniques that may be utilized to apply the castable reactive liquids employed in the present invention.

However, golf balls of the invention may be made by any known technique to those skilled in the art.

Examples of yet other materials which may be suitable for incorporating and coordinating in order to target and achieve desired playing characteristics or feel include plasticized thermoplastics, polyalkenamer compositions, polyester-based thermoplastic elastomers containing plasticizers, transparent or plasticized polyamides, thiolene compositions, poly-amide and anhydride-modified polyolefins, organic acid-modified polymers, and the like.

The at least one layer of inventive mixture may have a Shore D hardness of 5 or 8 or 10 or 12 or 14 or 28 or 30 or 32 or 34 or 35 or 38 or 40, or a Shore D hardness within a range having a lower limit and an upper limit of these values.

In another particular embodiment, the at least one layer of inventive mixture may have a Shore C hardness of 10 or 13 or 15 or 17 or 19 or 44 or 46 or 48 or 50 or 53 or 55, or a Shore C hardness within a range having a lower limit and an upper limit of these values.

In another particular embodiment, the at least one layer of inventive mixture may have a Shore D hardness of 25 or 28 or 30 or 32 or 35 or 36 or 38 or 40 or 42 or 45 or 48 or 50 or 54 or 56 or 60, or a Shore D hardness within a range having a lower limit and an upper limit of these values.

In another particular embodiment, the at least one layer of inventive mixture may have a Shore C hardness of 30 or 33 or 35 or 37 or 39 or 41 or 43 or 62 or 64 or 66 or 68 or 71 or 73 or 75, or a Shore C hardness within a range having a lower limit and an upper limit of these values.

In another particular embodiment, the at least one layer of inventive mixture may have a Shore D hardness of 42 or 44 or 47 or 51 or 53 or 58 or 60 or 65 or 72 or 77 or 80 or 84 or 91 or 95, or a Shore D hardness within a range having a lower limit and an upper limit of these values.

In another particular embodiment, the at least one layer of inventive mixture may have a Shore C hardness of 57 or 59 or 62 or 66 or 72 or 75 or 78 or 84 or 87 or 90 or 93 or 95 or 97 or 99, or a Shore C hardness within a range having a lower limit and an upper limit of these values.

The at least one layer of inventive mixture may be any layer of a golf ball. Accordingly, the golf ball construction, physical properties, and resulting performance may vary depending on the layer(s) of the ball that include the compositions of the invention.

The at least one layer of inventive mixture may have a hardness of about 20 Shore D to about 75 Shore D. In one embodiment, the hardness of a solid sphere formed from a composition of the invention ranges from about 30 Shore D to about 60 Shore D. In another embodiment, the hardness ranges from about 40 Shore D to about 50 Shore D.

In another aspect of the present invention, golf ball layers consisting of the inventive mixture may have a hardness of about 45 Shore C to about 85 Shore C. In one embodiment, the golf ball layer formed of the inventive mixture has a hardness of about 50 Shore C to about 80 Shore C. In another embodiment, the golf ball layer formed of the inventive mixture has a hardness of about 60 Shore C to about 75 Shore C.

The cores included in the golf balls of the present invention may have varying hardnesses depending on the particular golf ball construction. In one embodiment, the core hardness is about 20 Shore D to about 60 Shore D. In another embodiment, the core hardness is about 30 Shore D to about 50 Shore D.

The intermediate layers of the present invention may also vary in hardness depending on the specific construction of the ball. In one embodiment, the hardness of the intermediate layer is about 30 Shore D to about 65 Shore D. In another embodiment, the hardness of the intermediate layer is about 40 Shore D to about 55 Shore D.

As with the core and intermediate layers, the cover hardness may vary depending on the construction and desired characteristics of the golf ball. In one embodiment, the hardness of the cover layer is about 40 Shore D to about 65 Shore D. In another embodiment, the hardness of the cover layer is about 50 Shore D to about 60 Shore D.

Golf balls of the present invention may be further painted, coated, or surface treated for particular benefits. For example, golf balls of the invention may be coated with urethanes, urethane hybrids, ureas, urea hybrids, epoxies, polyesters, acrylics, or combinations thereof in order to obtain an extremely smooth, tack-free surface. If desired, more than one coating layer can be used. The coating layer(s) may be applied by any suitable method known to those of ordinary skill in the art. Any of the golf ball layers may be surface treated by conventional methods including blasting, mechanical abrasion, corona discharge, plasma treatment, and the like, and combinations thereof.

Hardness measurements are made pursuant to ASTM D-2240 “Indentation Hardness of Rubber and Plastic by Means of a Durometer.” The hardness of a core, cover, or intermediate layer may be measured directly on the surface of a layer or alternatively, at the midpoint of the given layer in a manner similar to measuring the geometric center hardness of a core layer that has been cut in half and the approximate geometric center of the core is measured perpendicular to the sectioned core. For example, the hardness of the inner cover layer may be measured at the midpoint of the layer after the ball has been cut in half. A midpoint hardness measurement is preferably made for the inner and intermediate cover layers. The midpoint hardness of a cover layer is taken at a point equidistant from the inner surface and outer surface of the layer to be measured. Once one or more cover or other layers surround a layer of interest, the exact midpoint may be difficult to determine, therefore, for the purposes of the present invention, the measurement of “midpoint” hardness of a layer is taken within plus or minus 1 mm of the measured midpoint of the layer. A surface hardness measurement is preferably made for the outer cover layer. In these instances, the hardness is measured on the outer surface (cover) of the ball.

In turn, material hardness is measured according to ASTM D2240 and generally involves measuring the hardness of a flat “slab” or “button” formed of the material. It should be understood that there is a fundamental difference between “material hardness” and “hardness as measured directly on a golf ball.” Hardness as measured directly on a golf ball (or other spherical surface) typically results in a different hardness value than material hardness. This difference in hardness values is due to several factors including, but not limited to, ball construction (i.e., core type, number of core and/or cover layers, etc.), ball (or sphere) diameter, and the material composition of adjacent layers. It should also be understood that the two measurement techniques are not linearly related and, therefore, one hardness value cannot easily be correlated to the other. Unless stated otherwise, the hardness values given herein for cover materials are material hardness values measured according to ASTM D2240, with all values reported following 10 days of aging at 50% relative humidity and 23° C.

Compression is an important factor in golf ball design. For example, the compression of the core can affect the ball's spin rate off the driver and the feel. In fact, the compositions and methods of the present invention result in golf balls having increased compressions and ultimately an overall harder ball. The harder the overall ball, the less deformed it becomes upon striking, and the faster it breaks away from the golf club.

As disclosed in Jeff Dalton's Compression by Any Other Name, Science and Golf IV, Proceedings of the World Scientific Congress of Golf (Eric Thain ed., Routledge, 2002) (“J. Dalton”), several different methods can be used to measure compression, including Atti compression, Riehle compression, load/deflection measurements at a variety of fixed loads and offsets, and effective modulus. For purposes of the present invention, “compression” refers to Atti compression and is measured according to a known procedure, using an Atti compression test device, wherein a piston is used to compress a ball against a spring.

The Atti compression of golf balls formed from the compositions of the present invention may range from about 40 to about 120. In one embodiment, the Atti compression of golf balls formed from the compositions of the present invention range from about 55 to about 100. In another embodiment, the Atti compression of golf balls formed from the compositions of the present invention range from about 70 to about 90.

The coefficient of restitution or COR of a golf ball is a measure of the amount of energy lost when two objects collide. The COR of a golf ball indicates its ability to rebound and accounts for the spring-like feel of the ball after striking. As used herein, the term “coefficient of restitution” (COR) is calculated by dividing the rebound velocity of the golf ball by the incoming velocity when a golf ball is shot out of an air cannon. The COR testing is conducted over a range of incoming velocities and determined at an inbound velocity of 125 ft/s.

In this aspect, the present invention contemplates golf balls having CORs from about 0.700 to about 0.850 at an inbound velocity of about 125 ft/sec. In one embodiment, the COR is about 0.750 to about 0.800, preferably about 0.760 to about 0.790, and more preferably about 0.770 to about 0.780. In another embodiment, the ball has a COR of about 0.800 or greater. In yet another embodiment, the COR of the balls of the invention is about 0.800 to about 0.815.

Solid spheres (1.55 inches) formed of a mixture of the invention may have a COR of at least about 0.700 as well.

Golf balls of the present invention will typically have dimple coverage of 60% or greater, preferably 65% or greater, and more preferably 75% or greater. The United States Golf Association specifications limit the minimum size of a competition golf ball to 1.680 inches. There is no specification as to the maximum diameter, and golf balls of any size can be used for recreational play. Golf balls of the present invention can have an overall diameter of any size. The preferred diameter of the present golf balls is from 1.680 inches to 1.800 inches. More preferably, the present golf balls have an overall diameter of from 1.680 inches to 1.760 inches, and even more preferably from 1.680 inches to 1.740 inches.

Golf balls of the present invention preferably have a moment of inertia (“MOI”) of 70-95 g·cm², preferably 75-93 g·cm², and more preferably 76-90 g·cm². For low MOI embodiments, the golf ball preferably has an MOI of 85 g-cm² or less, or 83 g·cm² or less. For high MOI embodiment, the golf ball preferably has an MOI of 86 g-cm² or greater, or 87 g·cm² or greater. MOI is measured on a model MOI-005-104 Moment of Inertia Instrument manufactured by Inertia Dynamics of Collinsville, Conn. The instrument is connected to a PC for communication via a COMM port and is driven by MOI Instrument Software version #1.2.

Thermoplastic layers herein may be treated in such a manner as to create a positive or negative hardness gradient. In golf ball layers of the present invention wherein a thermosetting rubber is used, gradient-producing processes and/or gradient-producing rubber formulation may be employed. Gradient-producing processes and formulations are disclosed more fully, for example, in U.S. patent application Ser. No. 12/048,665, filed on Mar. 14, 2008; Ser. No. 11/829,461, filed on Jul. 27, 2007; Ser. No. 11/772,903, filed Jul. 3, 2007; Ser. No. 11/832,163, filed Aug. 1, 2007; Ser. No. 11/832,197, filed on Aug. 1, 2007; the entire disclosure of each of these references is hereby incorporated herein by reference.

Advantageously, the compositions of the present invention provide excellent physical properties such as heat stability as well as processability (excellent melt flow) and meanwhile produce a golf ball having desired properties such a CoR and compression and with soft feel.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

The invention described and claimed herein is not to be limited in scope by the specific embodiments herein disclosed, since these embodiments are intended as illustrations of several aspects of the invention. Any equivalent embodiments are intended to be within the scope of this invention. For example, the compositions of the invention may also be used in golf equipment such as putter inserts, golf club heads and portions thereof, golf shoe portions, and golf bag portions. Indeed, various modifications of the invention in addition to those shown and described herein will become apparent to those skilled in the art from the foregoing description. Such modifications are also intended to fall within the scope of the appended claims. All patents and patent applications cited in the foregoing text are expressly incorporate herein by reference in their entirety.

What is claimed is:

1. A golf ball comprising at least one layer having a spherical outer surface and consisting of a mixture of a layer composition and a trigonal bipyramidal coordination complex composition that comprises trigonal bipyramidally coordinated metal cations to create a predetermined overall golf ball color appearance.

2. The golf ball of claim 1, wherein the trigonal bipyramidal coordination complex composition satisfies the general formula
AM₁₋ₓM′ₓM″_{y}O_{3+y},
wherein A comprises at least one of Mg, Sc, Y, Ti, Fe, Zn, Al, Ga, In, Sn, Gd, Td, Dy, Ho, Er, Tm, Yb, or Lu;
wherein M comprises (i) at least one of Mg, Sc, Y, Ti, Fe, Zn, Al, Ga, In, Sn, Gd, Td, Dy, Ho, Er, Tm, or Yb; or (ii) a 1:1 mixture of M_{A} and M_{B} cations, wherein M_{A} is at least one of Zn, Mg, or Cu; and M_{B} is at least one of Ti or Sn;
wherein M′ is at least one of Mn, Fe, Al, Ga, In; and
wherein M″ is at least one of Mg, Zn, or Cu; and
wherein 0.8≥x.>0.0; and y is an integer from 0 to 15.

3. The golf ball of claim 2, wherein A is Y, M is In, M′ is Mn, and y=0, and 1.0.>x.>0.0 such that the predetermined overall golf ball color appearance is blue in the CIE L*a*b* color space.

4. The golf ball of claim 2, wherein the mixture comprises the trigonal bipyramidal coordination complex composition in an
amount of from about 1 wt. % to about 5 wt. % of the total weight % of the mixture.

5. The golf ball of claim 2, wherein the layer composition comprises a thermoset polyurethane and the layer has a cover hardness of from about 30 Shore D to about 70 Shore D.

6. The golf ball of claim 2, wherein the layer composition comprises a thermoplastic polyurethane and the layer has a cover hardness of from about 30 Shore D to about 70 Shore D.

7. The golf ball of claim 2, wherein the layer composition comprises an ionomer and the layer has a cover hardness of from about 30 Shore D to about 70 Shore D.

8. The golf ball of claim 2, wherein the layer composition comprises a thermoset rubber and the layer has a surface hardness of from about 45 Shore C to about 95 Shore C.

9. The golf ball of claim 2, wherein the at least one layer is a core layer, an intermediate layer, a cover layer, or combinations thereof.

10. The golf ball of claim 2, wherein the at least one layer is a coating layer.

11. The golf ball of claim 10, wherein the mixture of the coating layer achieves a Sward rocker hardness of about 5 or greater in about 60 minutes or less.

12. The golf ball of claim 10, wherein the mixture of the coating layer achieves a Sward rocker hardness of about 10 or greater in about 60 minutes or less.

13. The golf ball of claim 10, wherein the mixture of the coating layer has a fully cured Sward rocker hardness of from about 30 to 80.

14. The golf ball of claim 10, wherein the mixture of the coating layer has a pencil hardness of 3H or less.

15. The golf ball of claim 10, wherein the mixture of the coating layer has a pencil hardness of HB or less.

16. The golf ball of claim 10, wherein the mixture of the coating layer has a pencil hardness of from about 3H to about 7H.

17. The golf ball of claim 10, wherein the coating layer composition comprises at least one of a latex, a lacquer, and an enamel.

18. The golf ball of claim 10, wherein the coating layer composition comprises at least one of a urethane, an acrylic, an epoxy, a urethane acrylate, and an alkyd.

19. The golf ball of claim 2, wherein the layer composition is opaque or translucent.

20. The golf ball of claim 2, wherein the predetermined overall golf ball color appearance is tinted white, wherein the layer composition comprises a white pigment, and the trigonal bipyramidal coordination complex composition produces a tinted white overall golf ball color appearance that is brighter than a white color appearance of the layer composition.

21. The golf ball of claim 20, wherein the mixture comprises the trigonal bipyramidal coordination complex composition in an amount of from about 0.001 wt. % to about 0.5 wt. % of the total weight % of the mixture.

22. The golf ball of claim 2, wherein the layer composition comprises at least one of a thermoset polyurethane, a thermoplastic polyurethane, an ionomer, or a thermoset rubber.

23. The golf ball of claim 2, wherein a color appearance of the golf ball has an L* value in the CIE L*a*b* color space that is between an L* value of the layer composition and an L* value of the trigonal bipyramidal coordination complex composition.

24. The golf ball of claim 23, wherein the trigonal bipyramidal coordination complex composition is included in the mixture in an amount such that the color appearance of the golf ball has an L* value in the CIE L*a*b* color space that is closer to the L* value of the trigonal bipyramidal coordination complex composition than to the L* value of the layer composition.

25. The golf ball of claim 23, wherein the layer composition and the trigonal bipyramidal coordination complex composition have substantially similar a* values and b* values in the CIE L*a*b* color space.

26. The golf ball of claim 23, wherein the layer composition and the trigonal bipyramidal coordination complex composition have different a* values, different b* values, or different a* values and b* values.

27. The golf ball of claim 2, wherein a color appearance of the golf ball has an L* value in the CIE L*a*b* color space that is substantially similar to an L* value of the trigonal bipyramidal coordination complex composition.

28. The golf ball of claim 27, wherein the color appearance of the golf ball has an a* value in the CIE L*a*b* color space that is closer to an a* value of the trigonal bipyramidal coordination complex composition than to an a* value of the layer composition.

29. The golf ball of claim 28, wherein the color appearance of golf ball has a b* value in the CIE L*a*b* color space that is closer to a b* value of the trigonal bipyramidal coordination complex composition than to a b* value of the layer composition.

30. The golf ball of claim 2, wherein the mixture has an L* value in the CIE L*a*b* color space that is between an L* value of the layer composition and an L* value of the trigonal bipyramidal coordination complex composition.

31. The golf ball of claim 30, wherein the trigonal bipyramidal coordination complex composition is included in the mixture in an amount such that the mixture has an L* value in the CIE L*a*b* color space that is closer to an L* value of the trigonal bipyramidal coordination complex composition than to an L* value of the layer composition.

31. The golf ball of claim 2, wherein the at least one layer has a thickness greater than 0.002 inches.

32. The golf ball of claim 2, wherein the at least one layer has a thickness greater than 0.007 inches.

33. The golf ball of claim 2, wherein the at least one layer has a thickness of greater than 0.010 inches.

34. The golf ball of claim 2, wherein the at least one layer has a thickness of greater than 0.050 inches.

35. The golf ball of claim 2, wherein the at least one layer has a thickness of greater than 0.10 inches.

36. The golf ball of claim 2, wherein the at least one layer is a core center having a diameter of from about 0.02 inches up to about 1.65 inches.
